(19) United States
(12) Patent Application Publication
(10) Pub. No.: US 2008/0208700 A1
(43) Pub. Date: Aug. 28, 2008

(54) METHOD FOR FACILITATING THE SALE, TRANSFER AND/OR ASSIGNMENT OF INTELLECTUAL PROPERTY

(76) Inventor: Heather Alisha DAVIS, Warren, OH (US)

Correspondence Address: HEATHER A. DAVIS, 736 KENMORE AVENUE SE, WARREN, OH, 44484, US

(21) Appl. No.: 11/625,618

(22) Filed: Jan. 22, 2007

Related U.S. Application Data
(60) Provisional application No. 60/760,416, filed on Jan. 20, 2006.
(60) Provisional application No. 60/760,417, filed on Jan. 20, 2006.

(51) Int. Cl. G06Q 30/00

(52) U.S. Cl. 705/26

(57) ABSTRACT

A new and improved method for facilitating the sale, transfer, and/or assignment of intellectual property is herein disclosed.

This application claims priority to a provisional patent application Ser. No. 60/760,416, filed Jan. 20, 2006, entitled THE INTELLECTUAL PROPERTY EXCHANGE and Ser. No. 60/760,417, filed Jan. 20, 2006, entitled THE INTELLECTUAL PROPERTY SEARCH ENGINE. This invention relates to the field of property transfers and auctions, and more particularly to the transfer and auction of intellectual property, and even more particularly to a method for facilitating the sale, transfer, and/or assignment of intellectual property.

### I. BACKGROUND OF THE INVENTION

A. Field of the Invention

B. Description of the Related Art

It is known in the art to provide online databases of patents, trademarks, and copyrights. These databases can be searched using various search criteria, and include text searching.

The present invention provides a new and improved method for facilitating the sale, transfer, and/or assignment of intellectual property, and overcomes certain difficulties inherent in the related inventions while providing better overall results.

### II. SUMMARY OF THE INVENTION

In accordance with one aspect of the present invention, a method for effecting exchange of intellectual property rights, which may be embodied in a global computer network, includes all types of intellectual property, including patents, copyrights, trademarks, trade names, trade secrets, and online business elements (e.g. domain names, website material and source code, software configurations, business methods, and related material for an online business).

In accordance with another aspect of the present invention, the intellectual property rights are exchanged or transferred, but not necessarily the underlying product or services covered by the intellectual property rights.

In accordance with another aspect of the present invention, the exchange includes the following forms: buy-out, assignment, fixed price, auction, licensing, trade/barter (cross-assignment or cross-licensing), and investment (e.g. for privately traded stock shares with dividends and/or capital or equity gains).

In accordance with another aspect of the present invention, some, or all, of the transactions can be conducted online, including negotiation of terms, offer/counter-offer, all being facilitated by the forms and mechanisms of the website, without requiring the website hosting business to be directly involved.

In accordance with another aspect of the present invention, the website owner can facilitate off-line, private interaction directly between a buyer and seller. The buyer and/or seller can choose whether the exchange of negotiation information pertaining to the intellectual property is to be public or private.

In accordance with another aspect of the present invention, the information submitted by the seller is placed into a “classifieds” format termed a listing, and all exchanges that take place for the rights to the intellectual property described in the listing are consummated between the buyer and the seller. The website owner may or may not hold interest in, or control of, any transactions that transpire on or through the website. The website provides a structure and an enabling means for the transaction.

In accordance with another aspect of the present invention, the information is verified, detailed, and available for transaction via the terms, rules, and regulations conveyed in a legal contract. The space needed to contain the contract is provided by the website, which enables the seller to optionally construct a legal contract, or to download a pre-existing legal contract that supports the transaction of particular rights. The downloaded contracts may be viewed at any time by pressing a button on the website. The website may provide standard contract forms or clauses to assist the seller in constructing the contract.

In accordance with another aspect of the present invention, the website is supported by user/advertiser fees rather than sales commissions.

In accordance with another aspect of the present invention, a seller of intellectual property rights may post a time limited advertisement for a pre-paid fee, the advertisement being presented in a searchable format.

In accordance with another aspect of the present invention, a prospective buyer of intellectual property rights may post a time limited advertisement for a pre-paid fee, the advertisement being presented in a searchable format.

In accordance with another aspect of the present invention, an inventor or company may post a time limited “Help wanted/Investors needed/Job opportunity” advertisement for a pre-paid fee, the advertisement being presented in a searchable format. For example, an inventor may want help in reducing to practice, developing, or marketing his inventive concept. Another example would be an inventor or start-up company may want help with venture capital. The aid/help could include, for example, technical or business consultation, technical work-for-hire, co-inventorship, investment capital, etc. Payment for help/aid can take non-monetary forms.

In accordance with another aspect of the present invention, a search engine is provided for an investor to search the website for investor criteria.

In accordance with another aspect of the present invention, individuals seeking investors can upload their business plan to the website. A button displayed in the individual's listing will access the plan for viewing in it's entirety by potential investors.

In accordance with another aspect of the present invention, an escrow account is provided for holding a deposit from a prospective buyer while purchase agreements are pending. An escrow deposit of a predetermined value preserves a priority right for purchase for a pre-arranged time period subject to pre-arranged conditions. The escrow deposit can take non-monetary forms as well.

In accordance with another aspect of the present invention, the escrow account can be managed by a qualified third party under contract with the website owner.

In accordance with another aspect of the present invention, the intellectual property listing information, as well as most other information displayed on the website, can be provided in multiple languages.

The inventive process provides an affordable and ethical means for private inventors to market their intellectual property rights when they do not wish to manufacture and/or sell the invention themselves.

The process limits disclosure of pending applications not otherwise made public. Outside information is general in nature, whereas inside information is only available to serious potential clients, who may be required to agree to confidentiality terms. The process also encourages interaction between corporations and private inventors, and provides an attractive tool for companies to place intellectual property needs into classified ad style listings.

Still other benefits and advantages of the invention will become apparent to those skilled in the art upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 is a print-out from the inventive website;

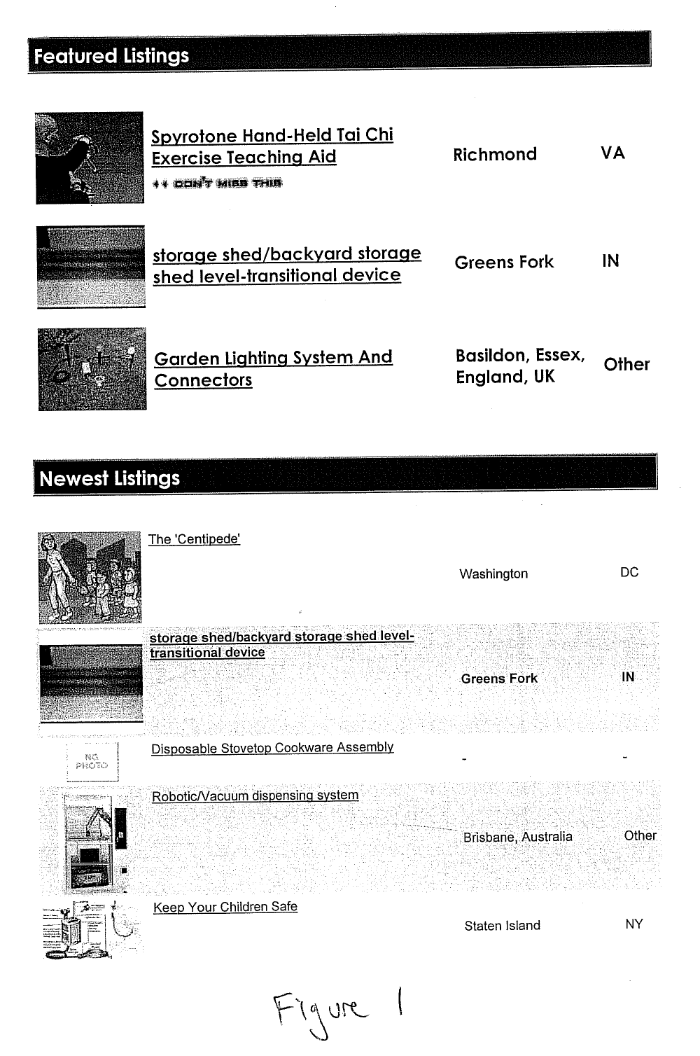

FIG. 2 is a print-out from the inventive website;

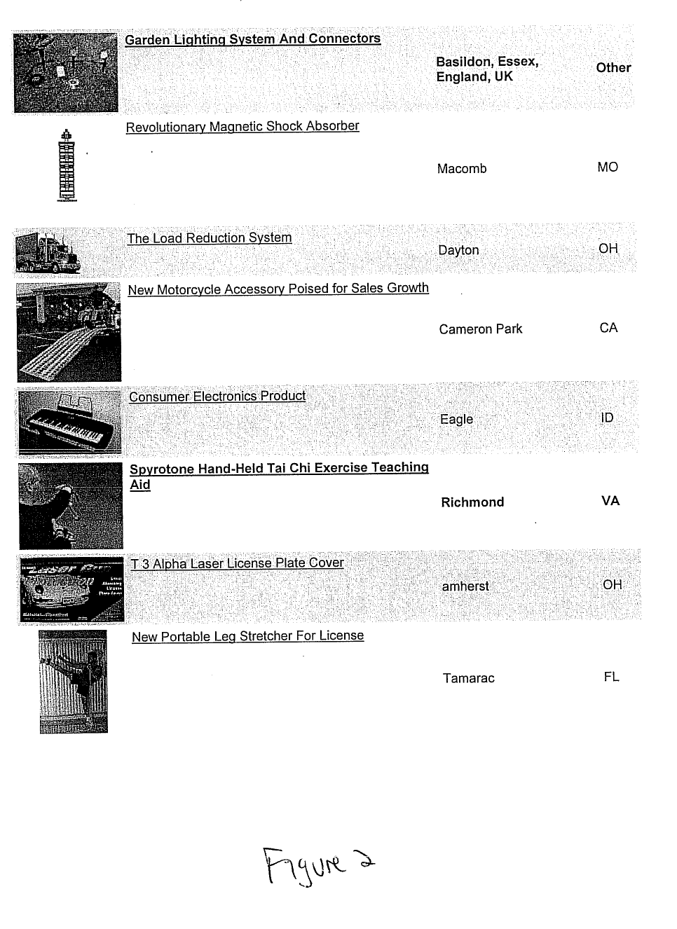

FIG. 3 is a print-out from the inventive website;

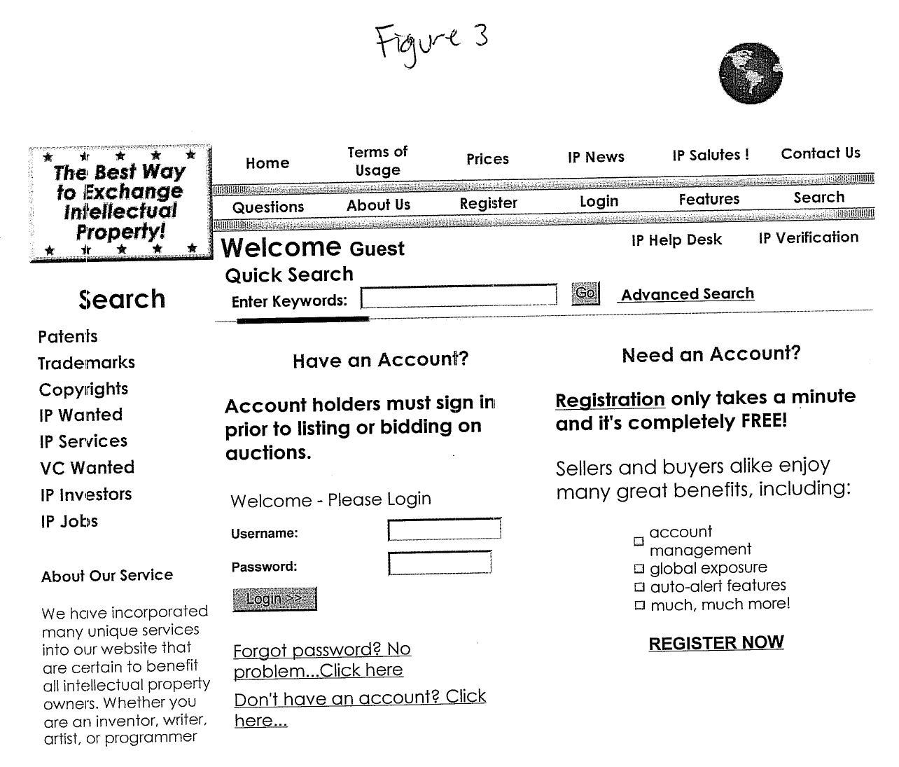

FIG. 4 is a print-out from the inventive website;

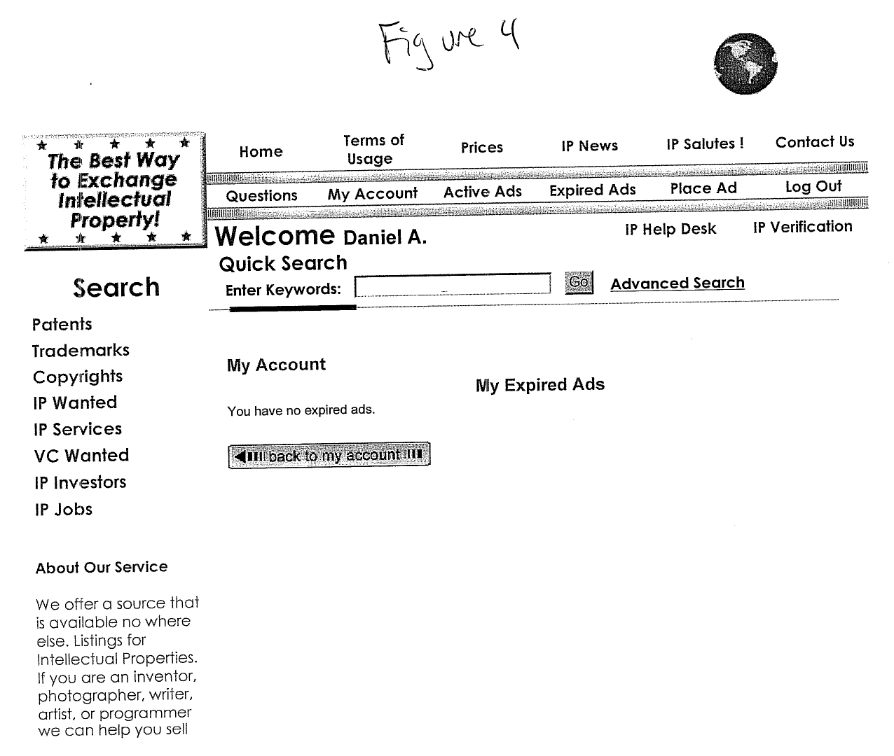

FIG. 5 is a print-out from the inventive website;

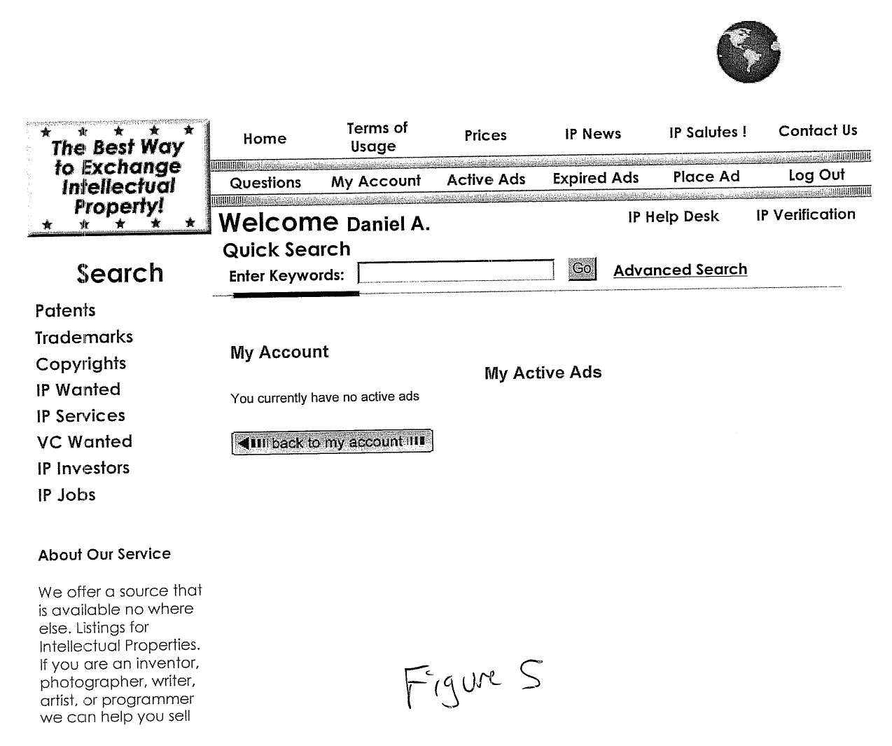

FIG. 6 is a print-out from the inventive website;

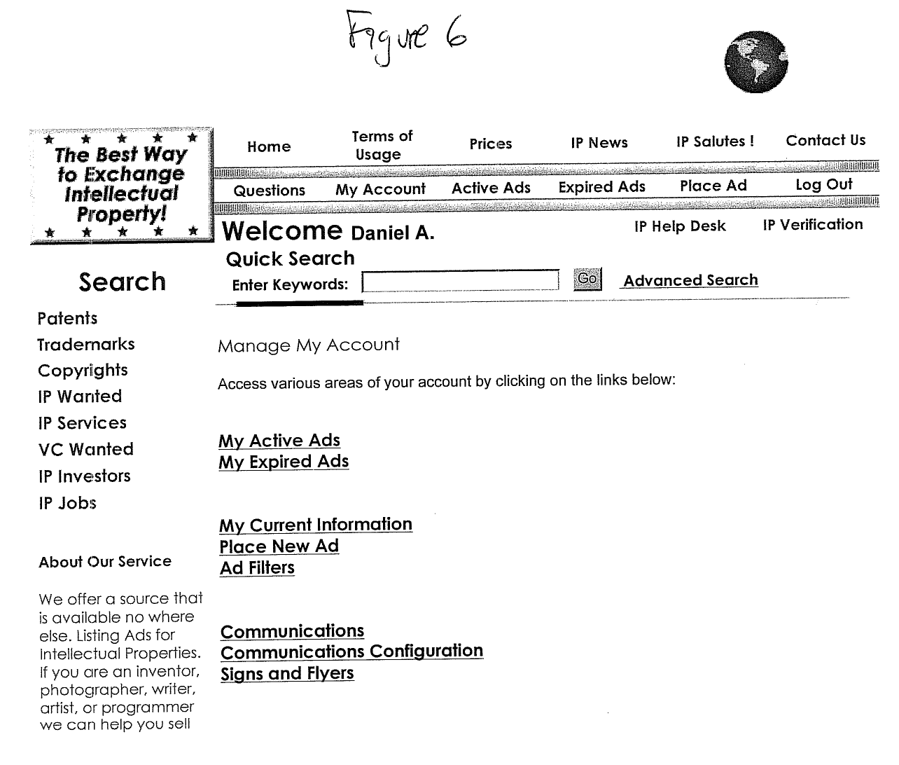

FIG. 7 is a print-out from the inventive website;

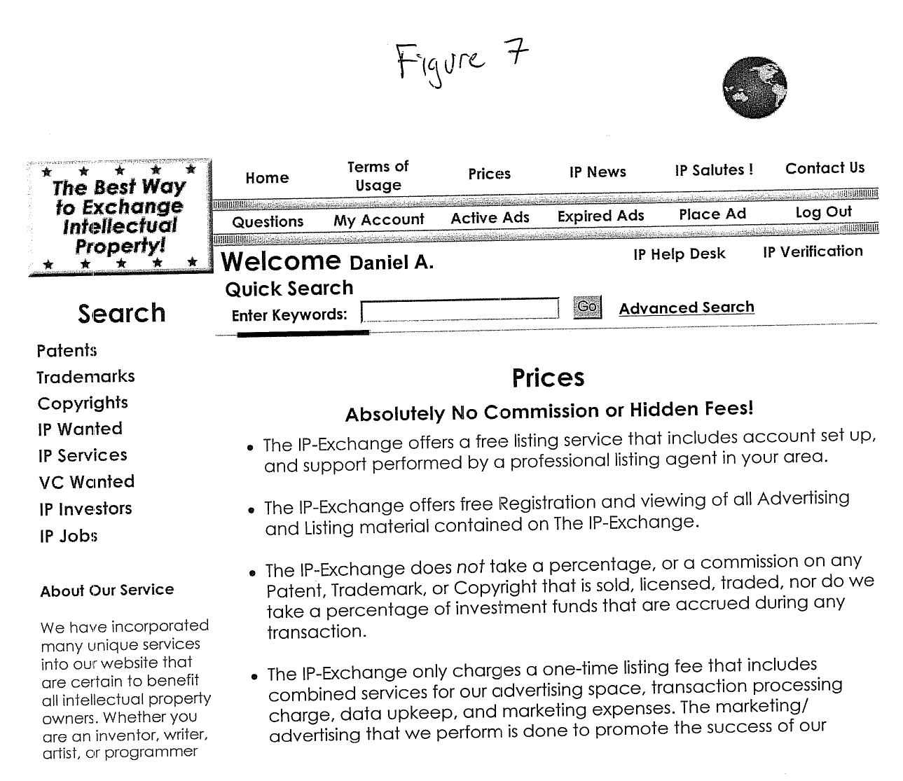

FIG. 8 is a print-out from the inventive website;

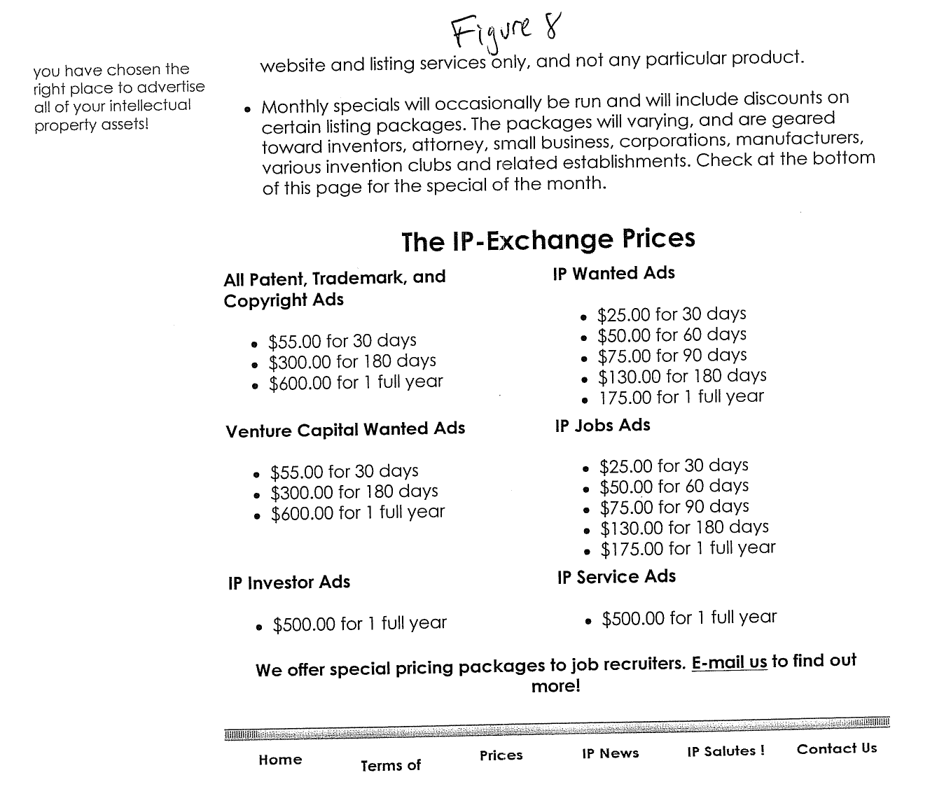

FIG. 9 is a print-out from the inventive website;

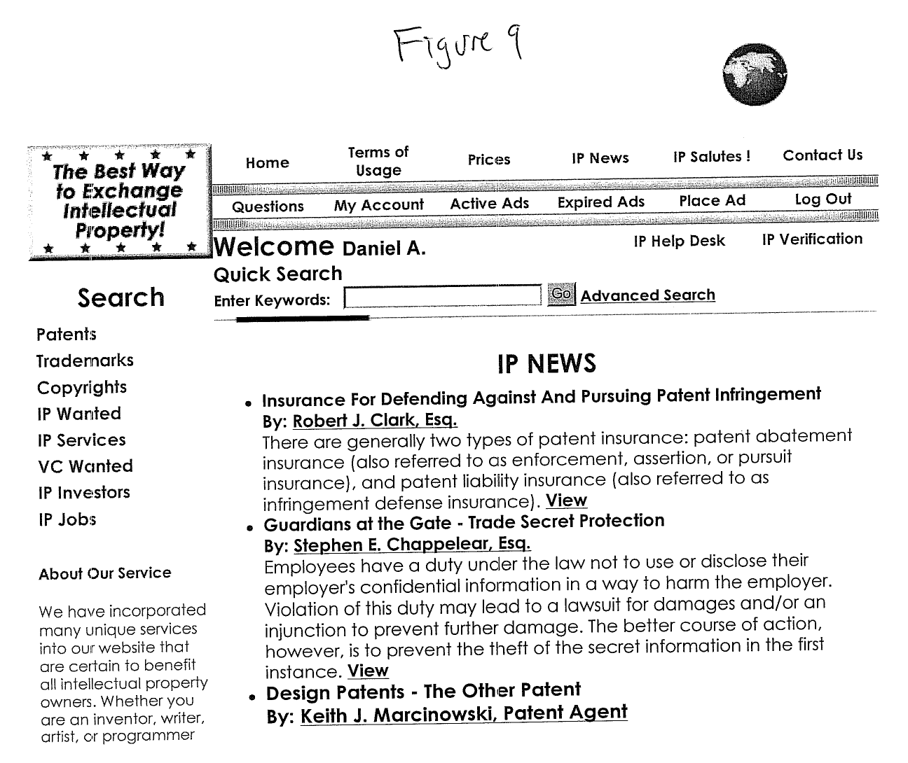

FIG. 10 is a print-out from the inventive website;

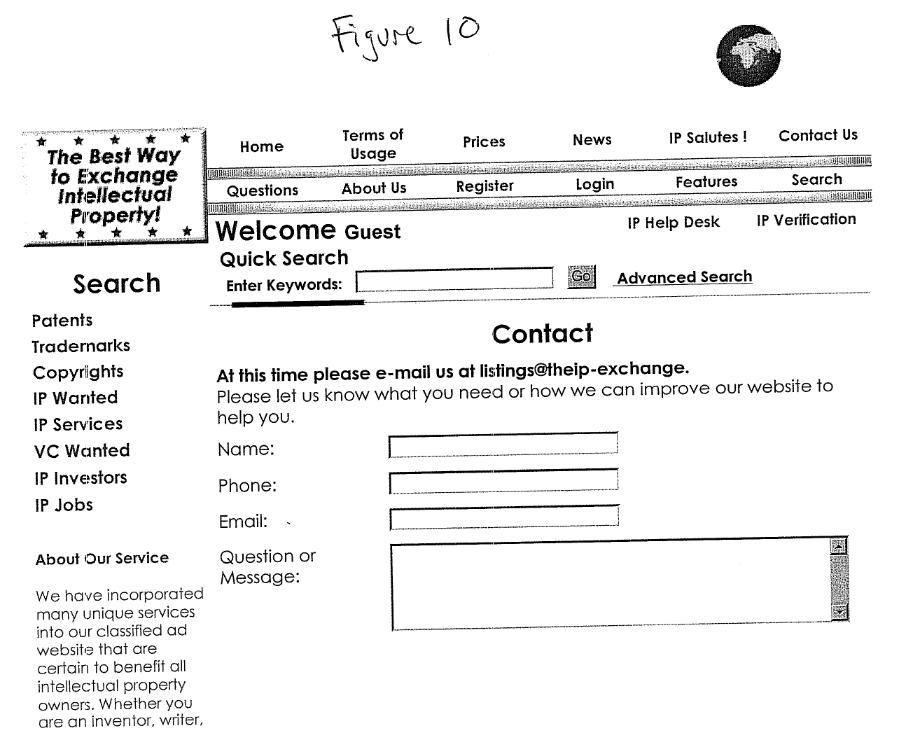

FIG. 11 is a print-out from the inventive website;

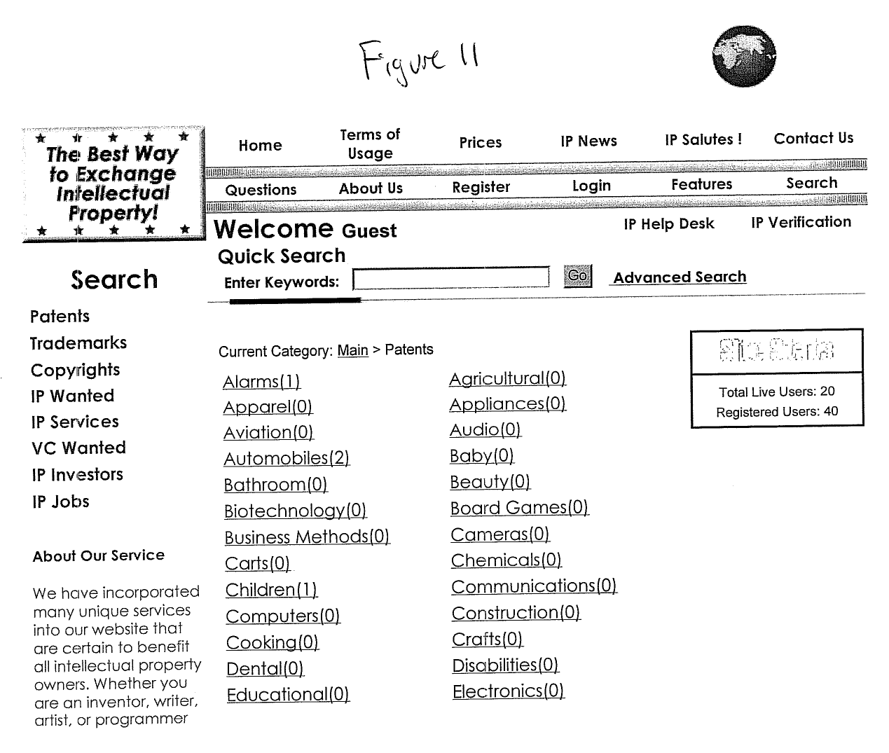

FIG. 12 is a print-out from the inventive website;

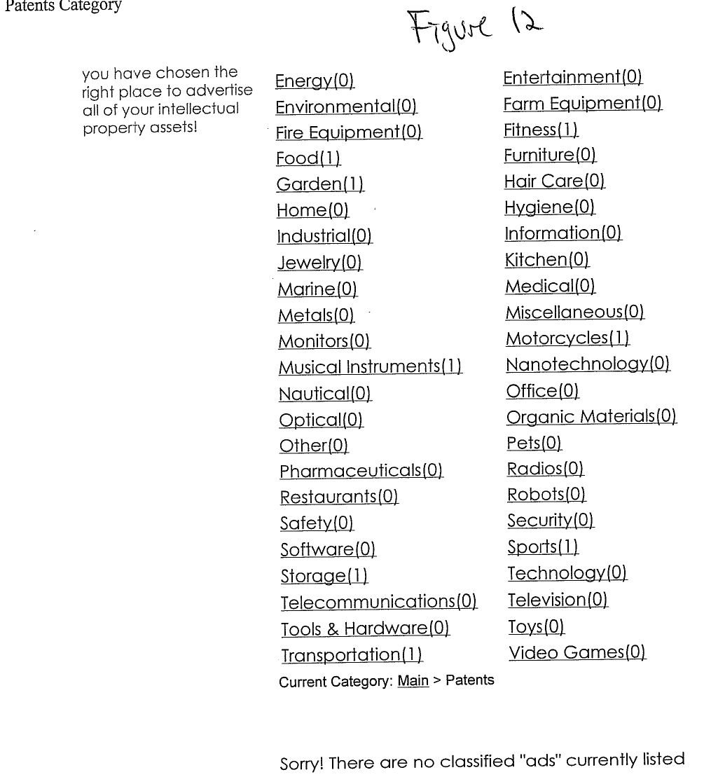

FIG. 13 is a print-out from the inventive website;

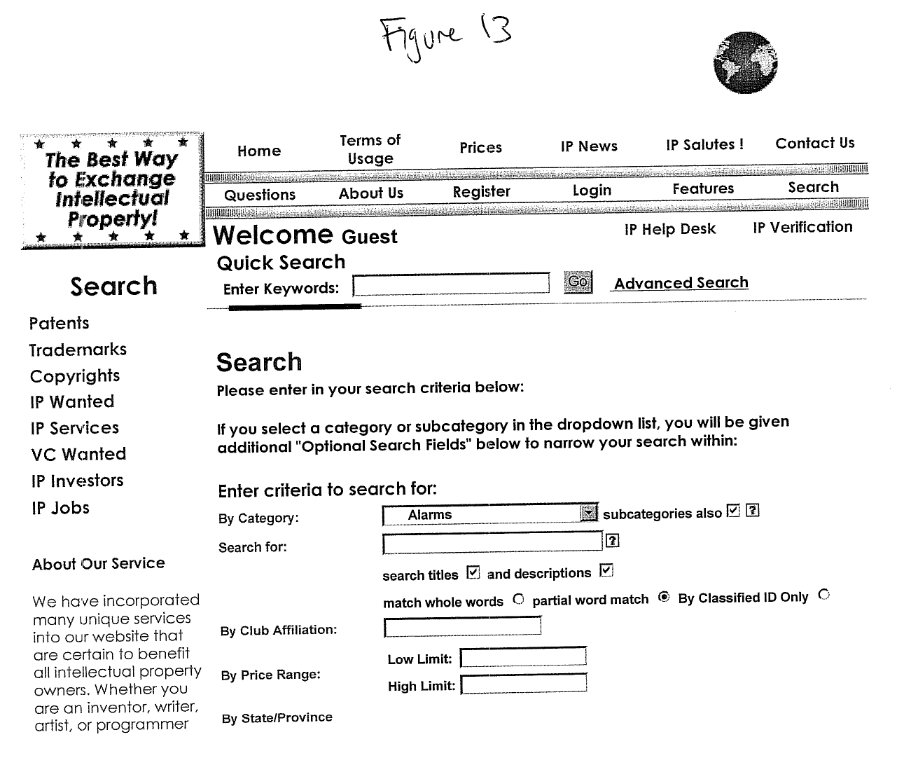

FIG. 14 is a print-out from the inventive website;

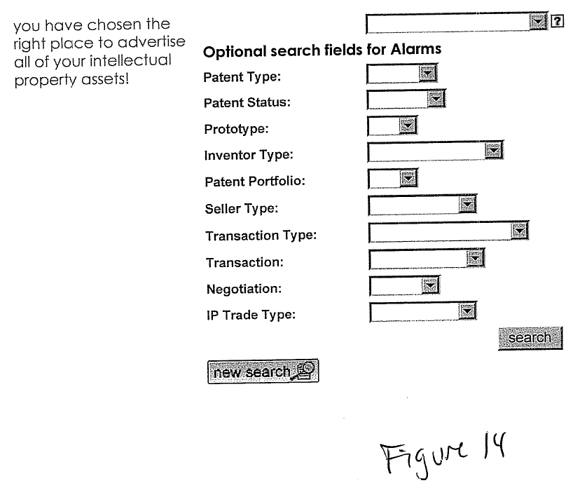

FIG. 15 is a print-out from the inventive website;

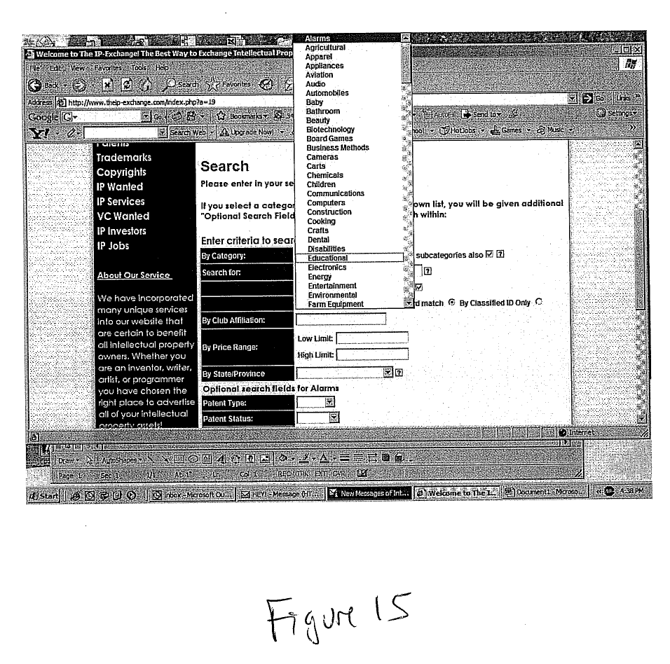

FIG. 16 is a print-out from the inventive website;

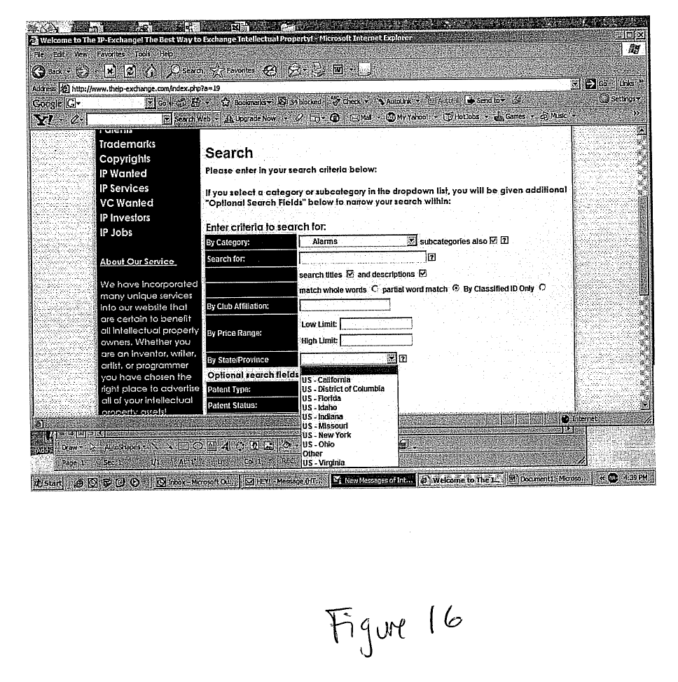

FIG. 17 is a print-out from the inventive website;

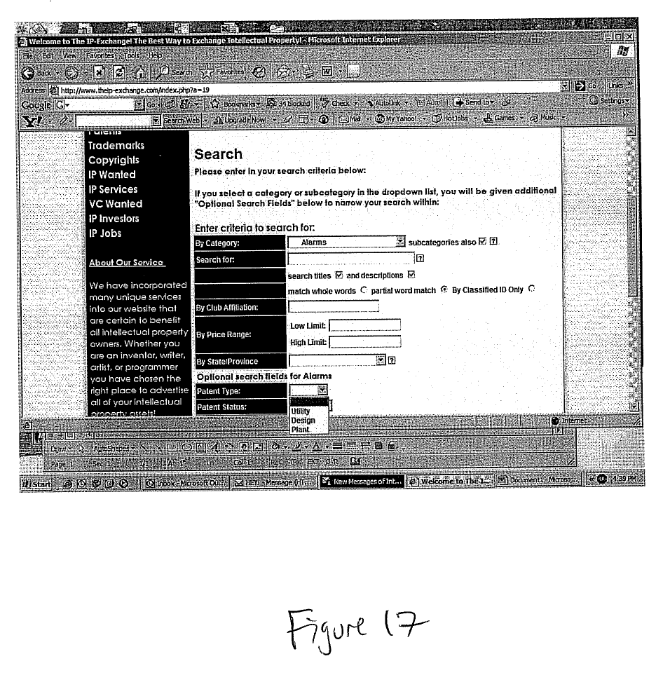

FIG. 18 is a print-out from the inventive website;

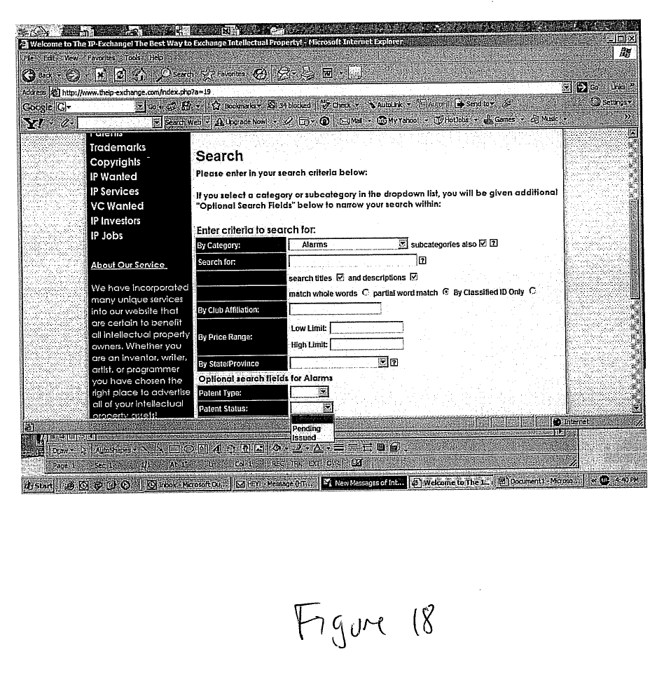

FIG. 19 is a print-out from the inventive website;

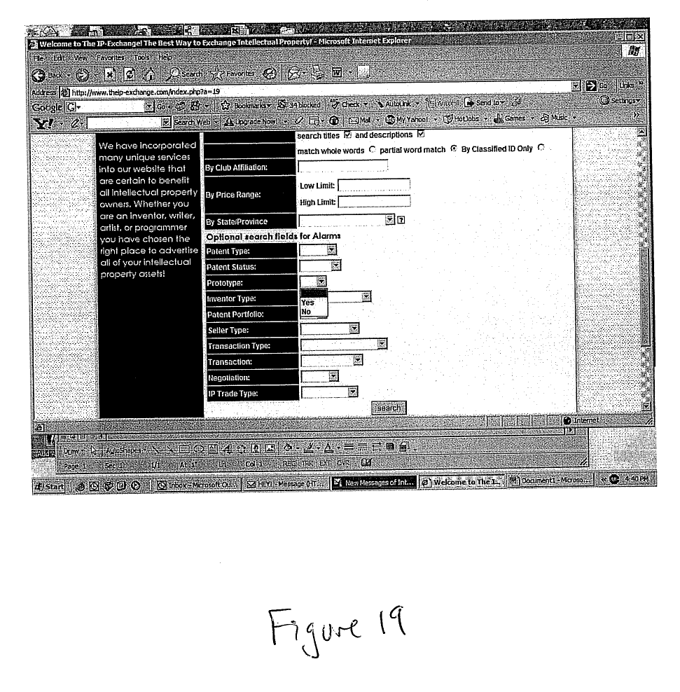

FIG. 20 is a print-out from the inventive website;

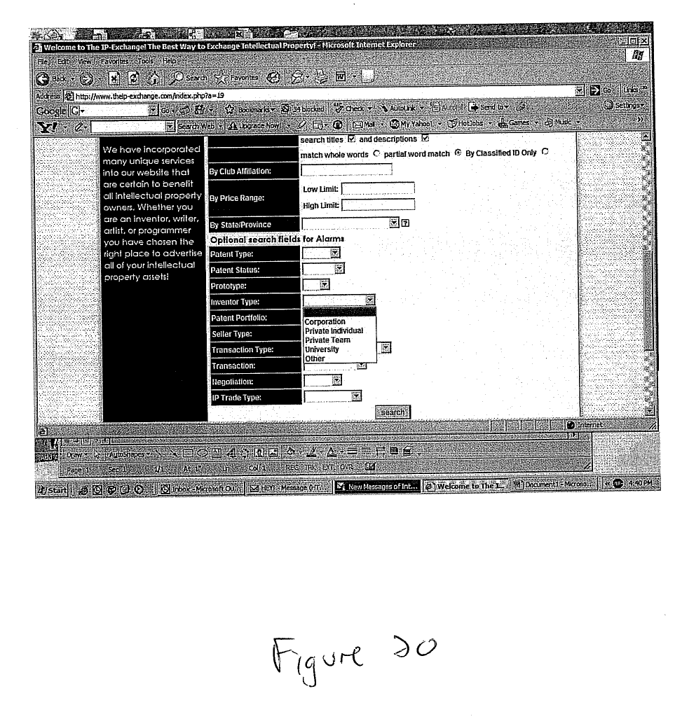

FIG. 21 is a print-out from the inventive website;

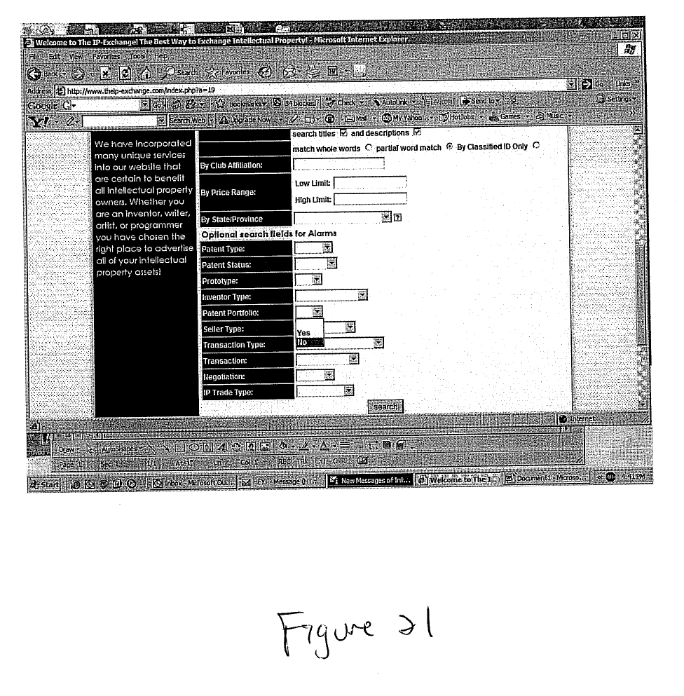

FIG. 22 is a print-out from the inventive website;

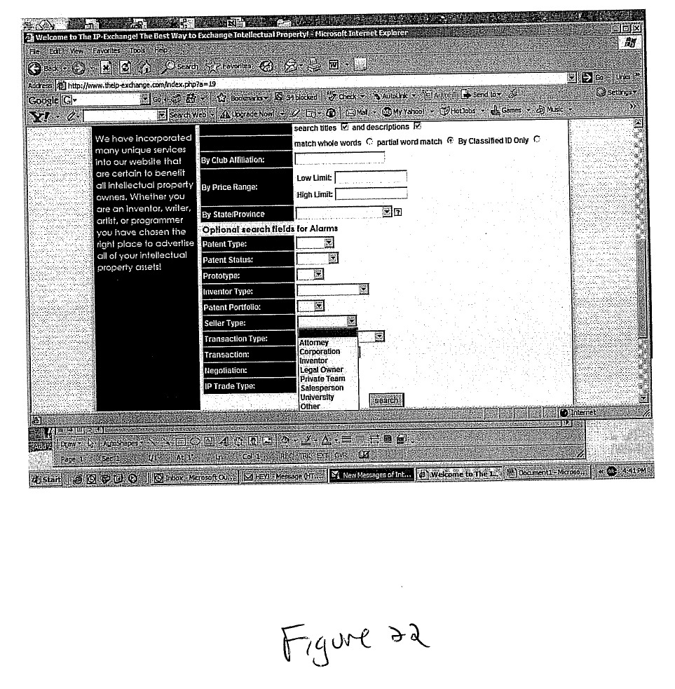

FIG. 23 is a print-out from the inventive website;

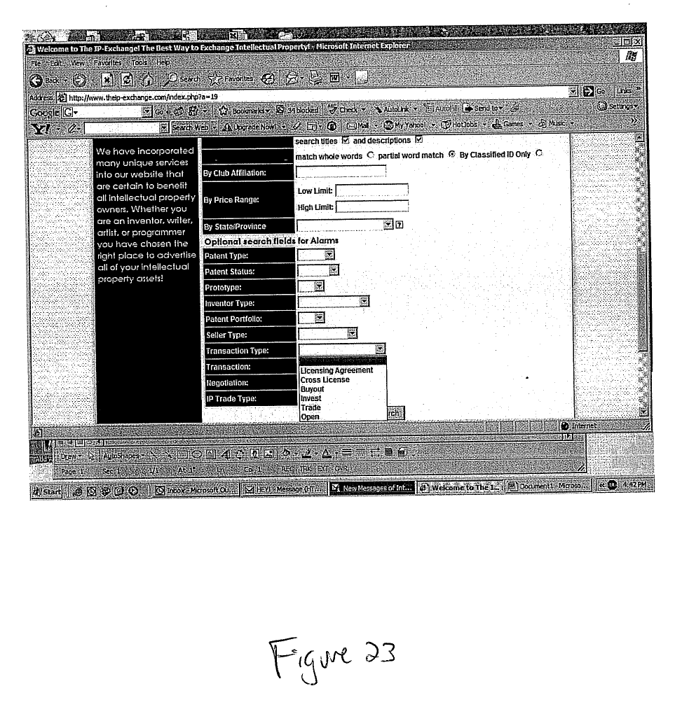

FIG. 24 is a print-out from the inventive website;

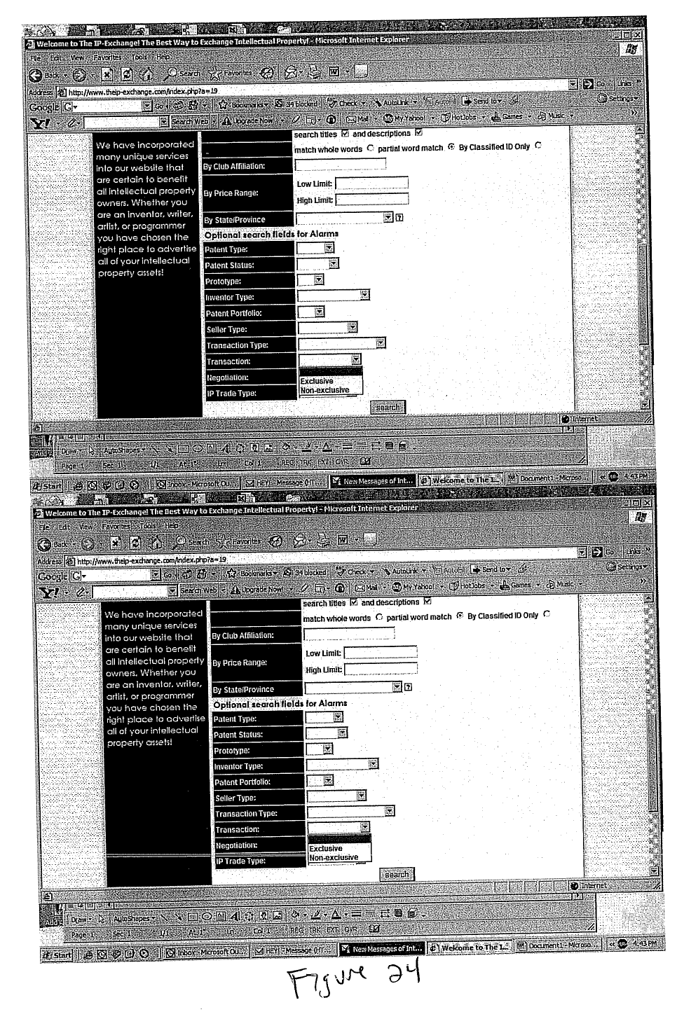

FIG. 25 is a print-out from the inventive website;

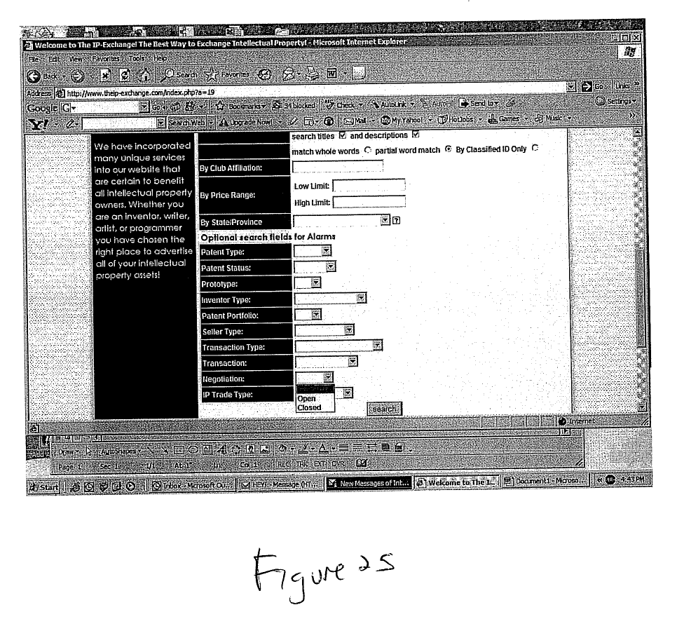

FIG. 26 is a print-out from the inventive website;

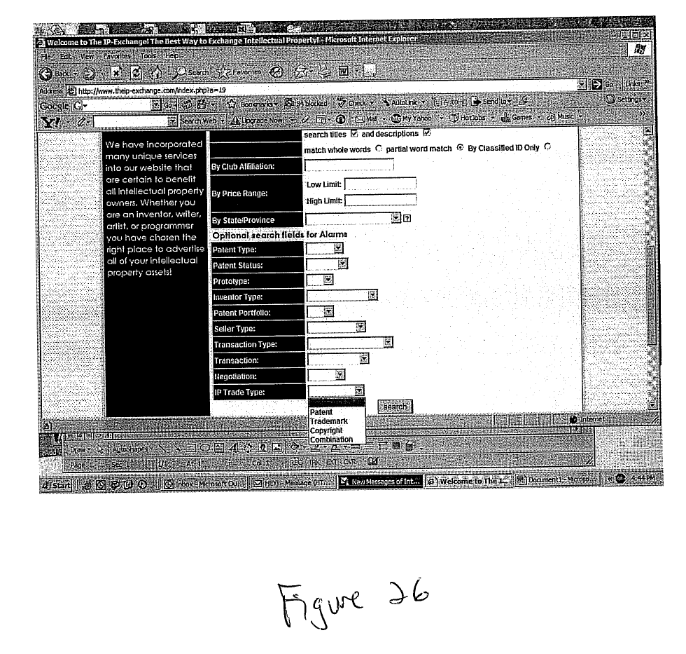

FIG. 27 is a print-out from the inventive website;

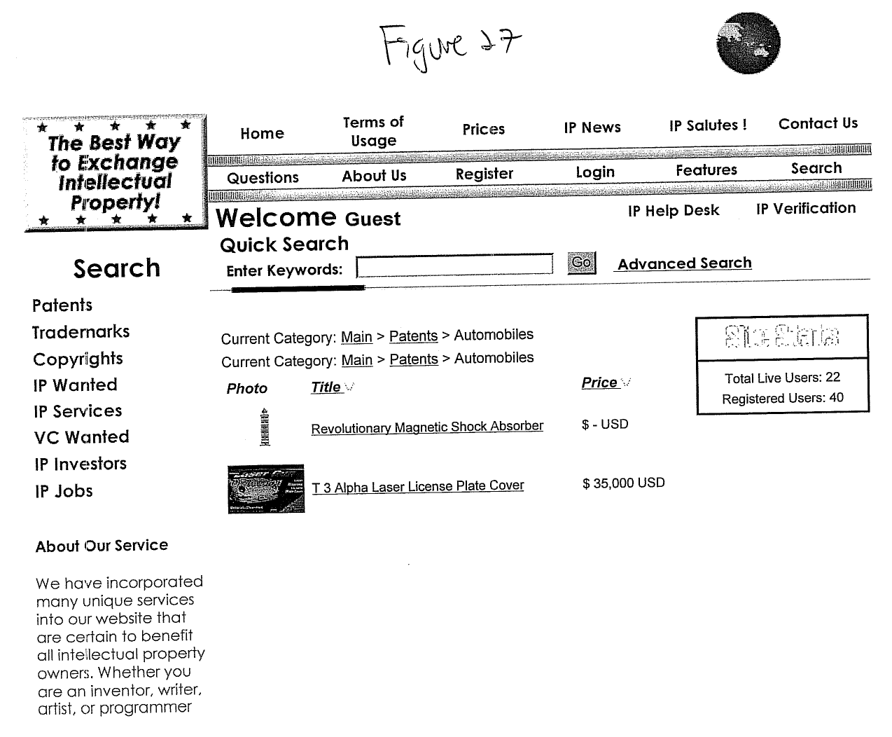

FIG. 28 is a print-out from the inventive website;

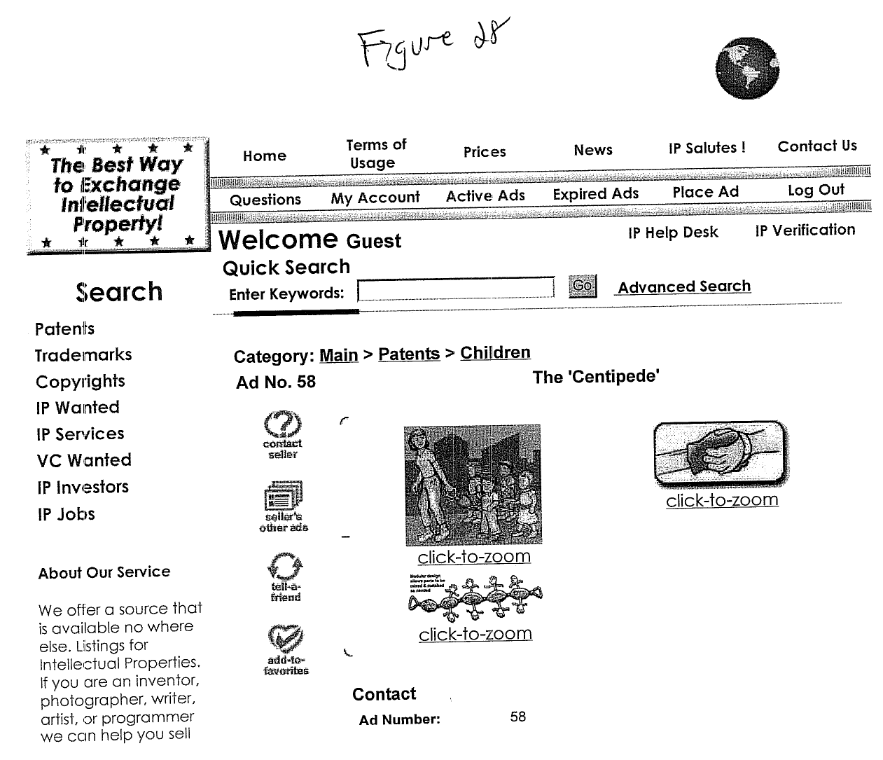

FIG. 29 is a print-out from the inventive website;

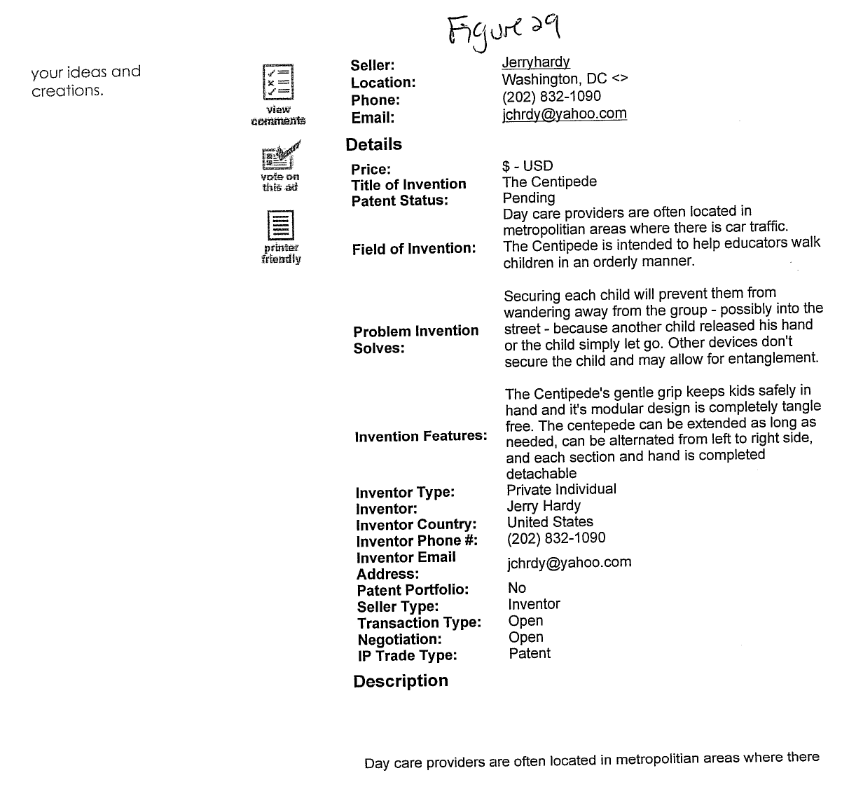

FIG. 30 is a print-out from the inventive website;

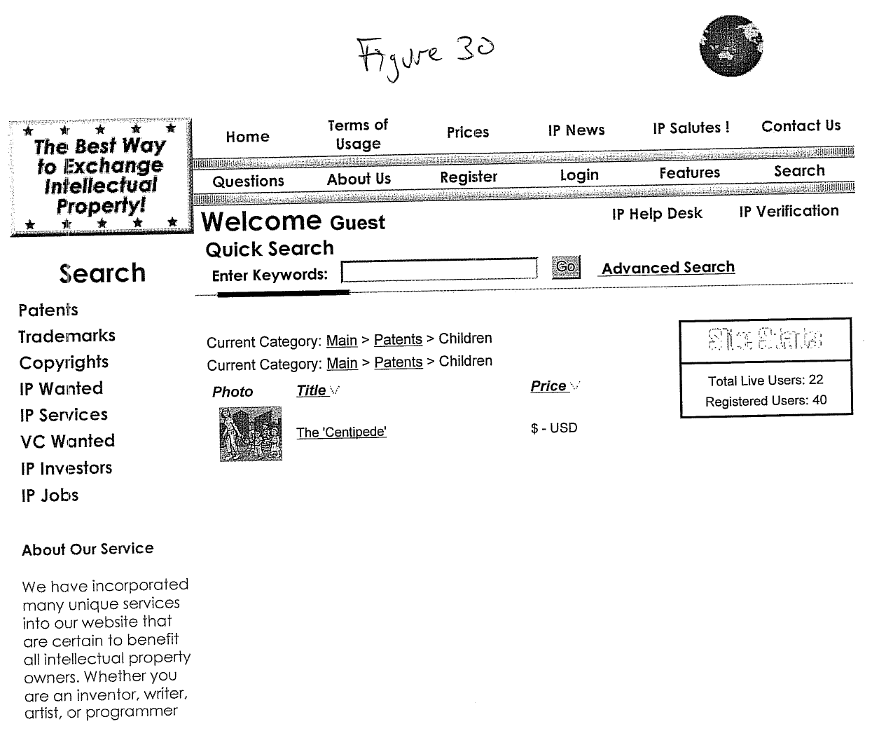

FIG. 31 is a print-out from the inventive website;

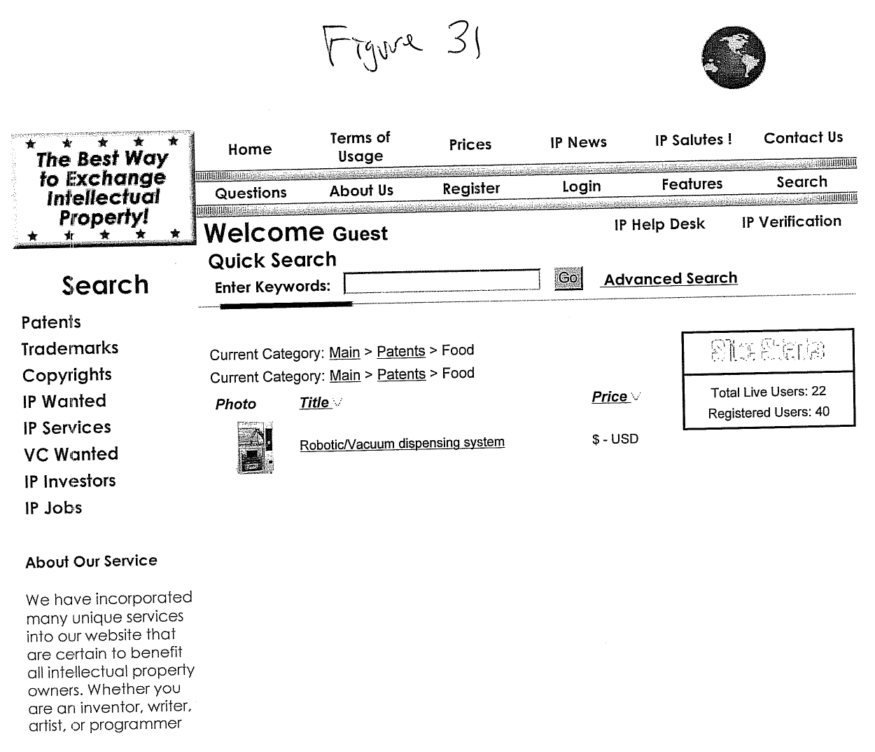

FIG. 32 is a print-out from the inventive website;

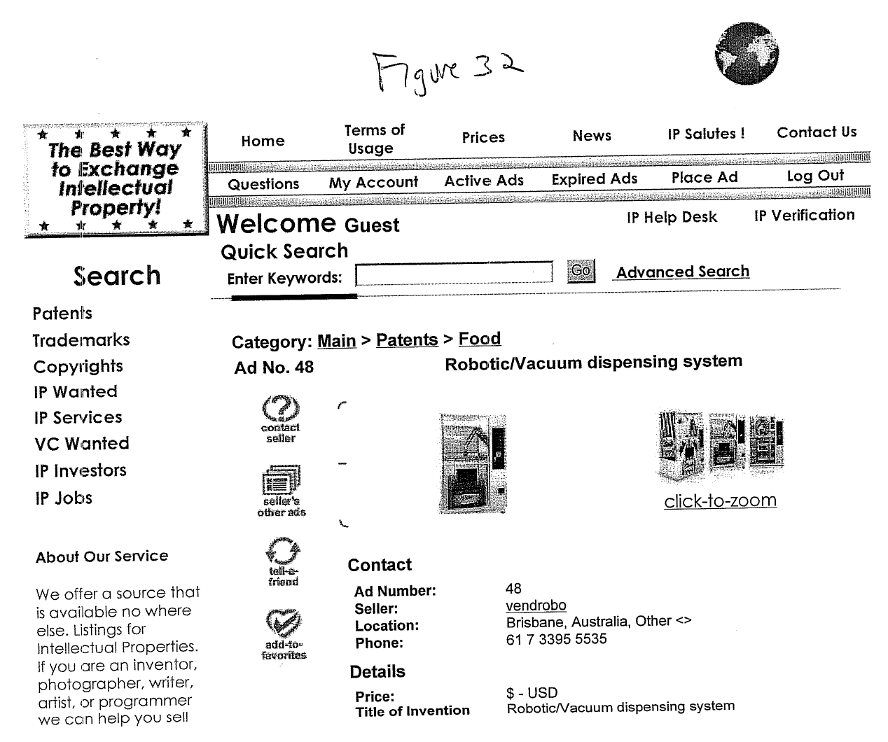

FIG. 33 is a print-out from the inventive website;

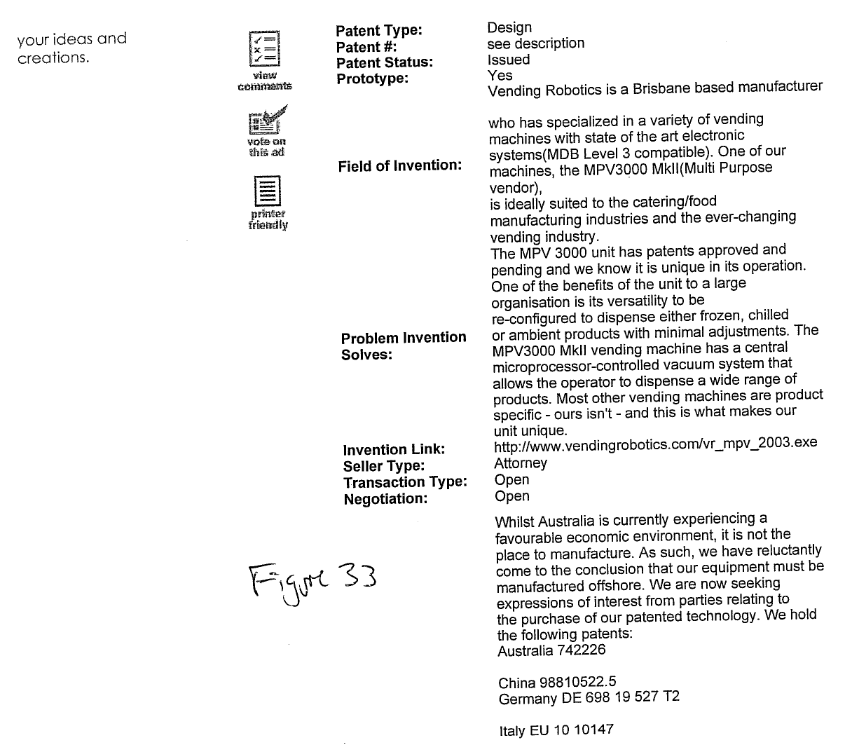

FIG. 34 is a print-out from the inventive website;

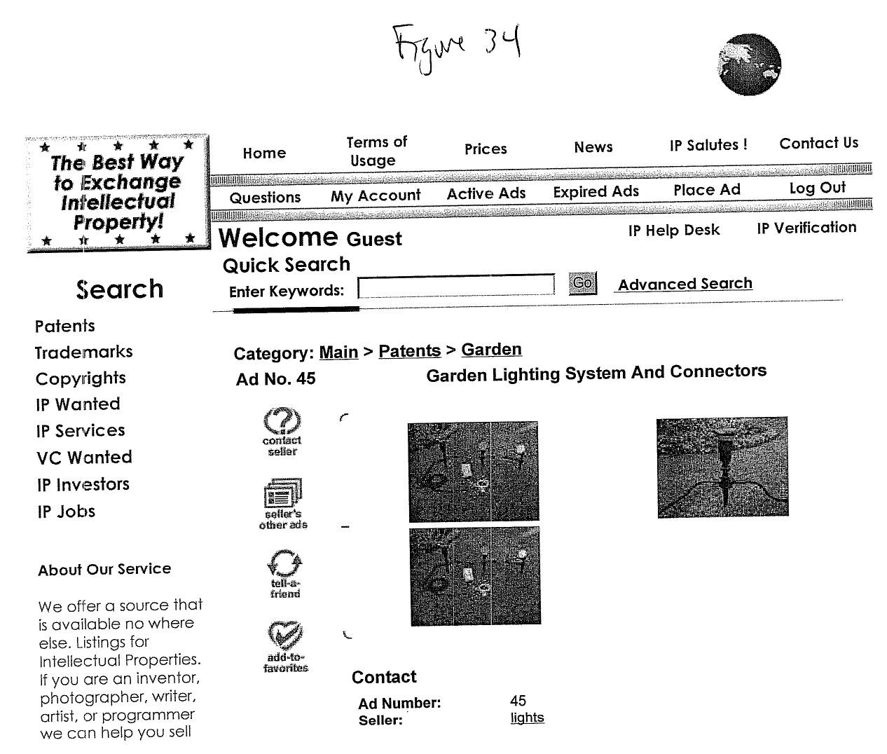

FIG. 35 is a print-out from the inventive website;

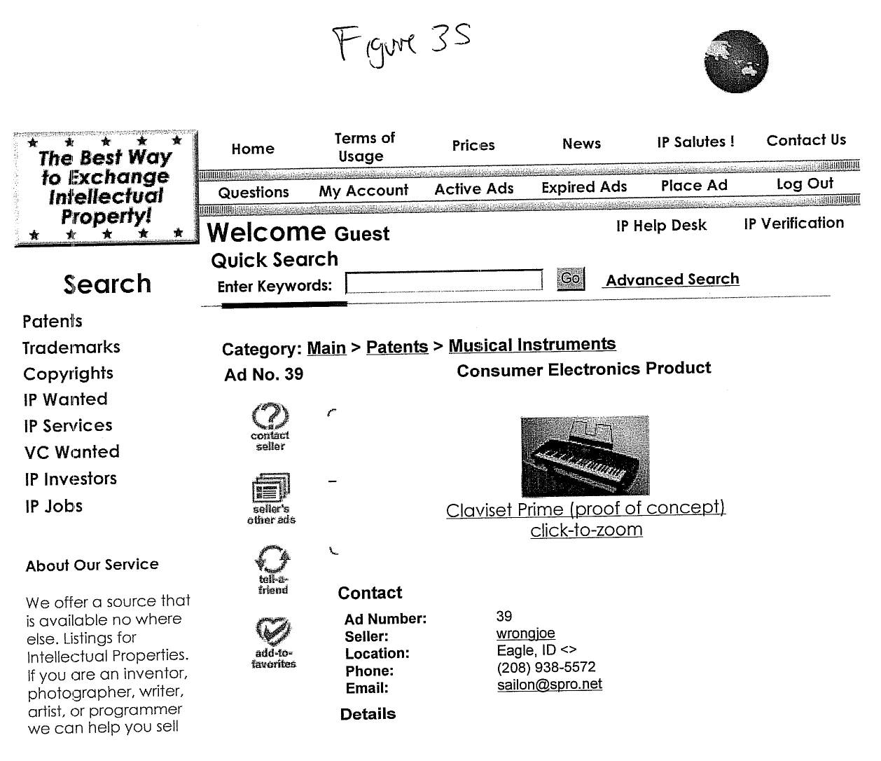

FIG. 36 is a print-out from the inventive website;

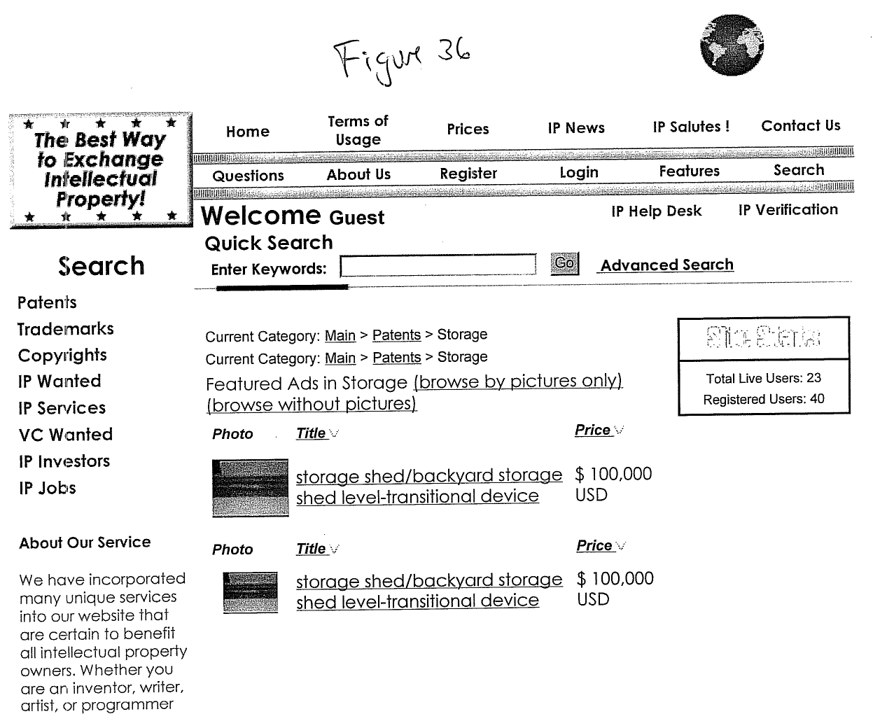

FIG. 37 is a print-out from the inventive website;

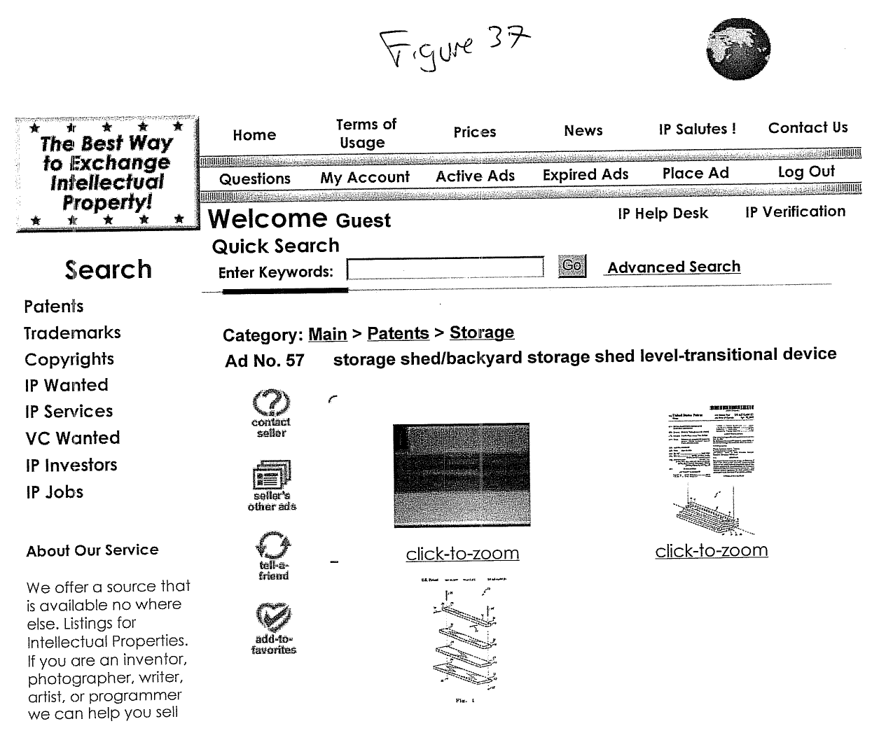

FIG. 38 is a print-out from the inventive website;

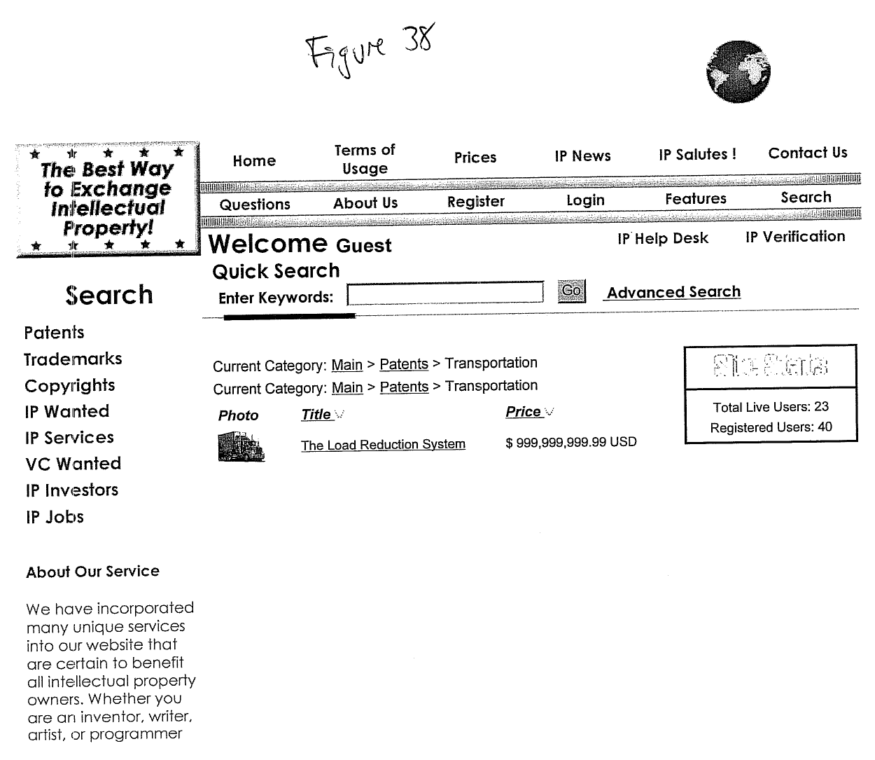

FIG. 39 is a print-out from the inventive website;

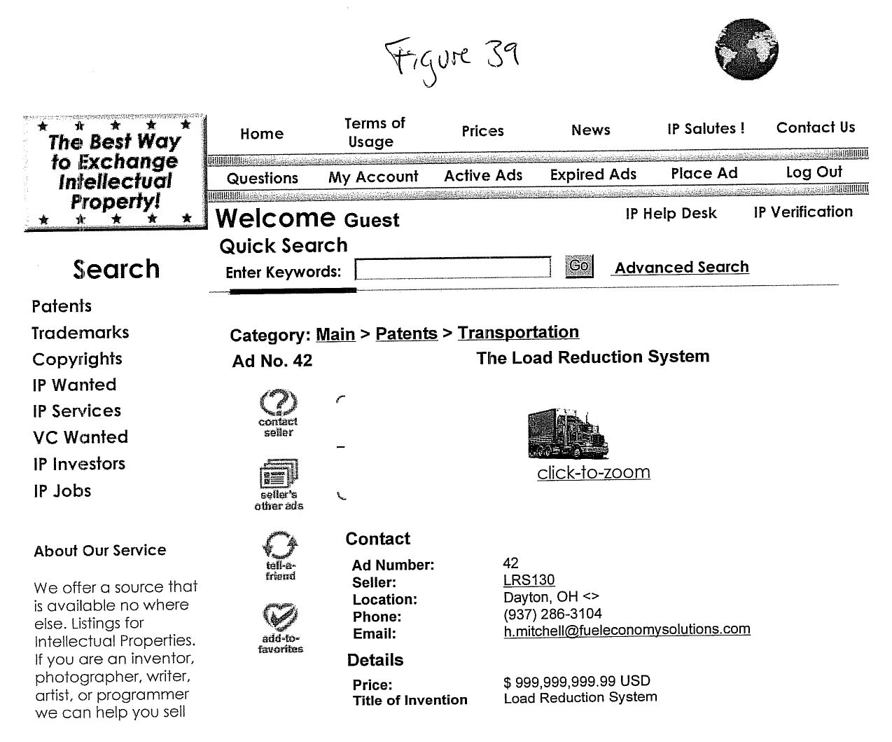

FIG. 40 is a print-out from the inventive website;

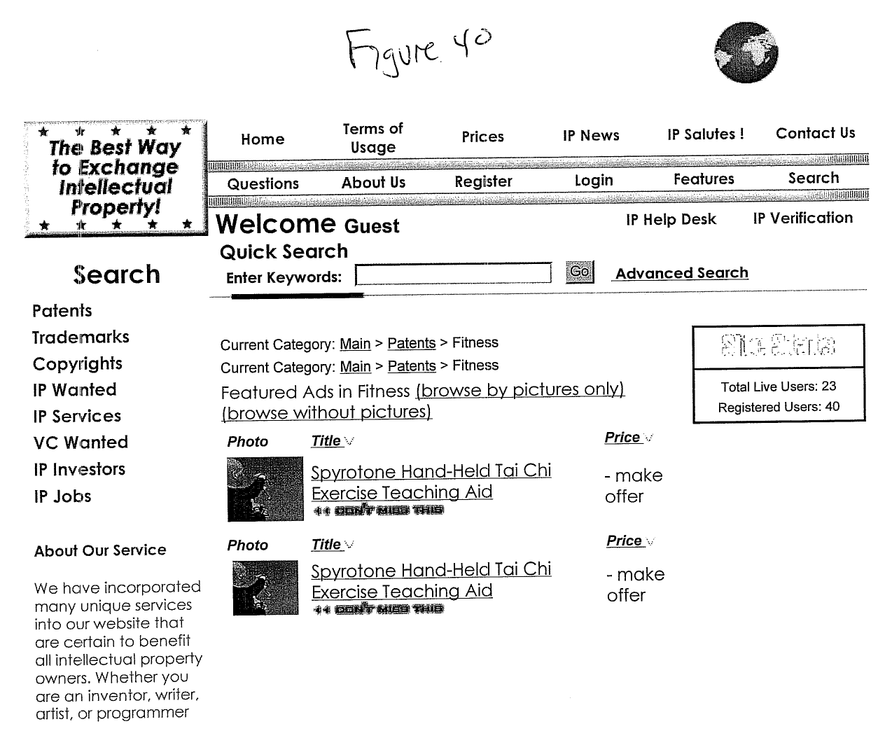

FIG. 41 is a print-out from the inventive website;

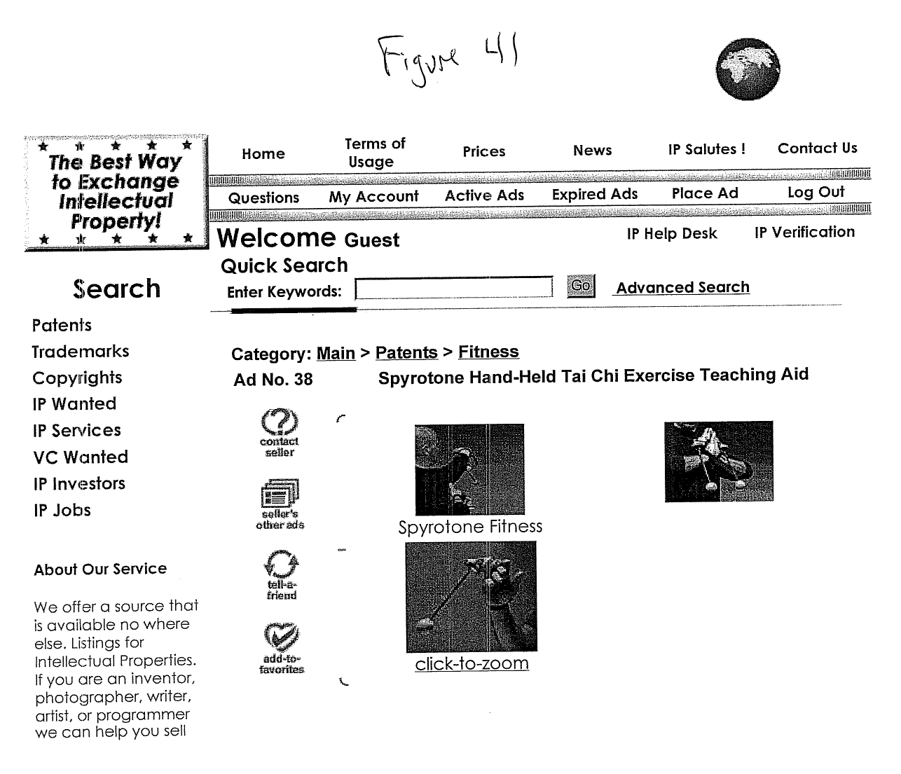

FIG. 42 is a print-out from the inventive website;

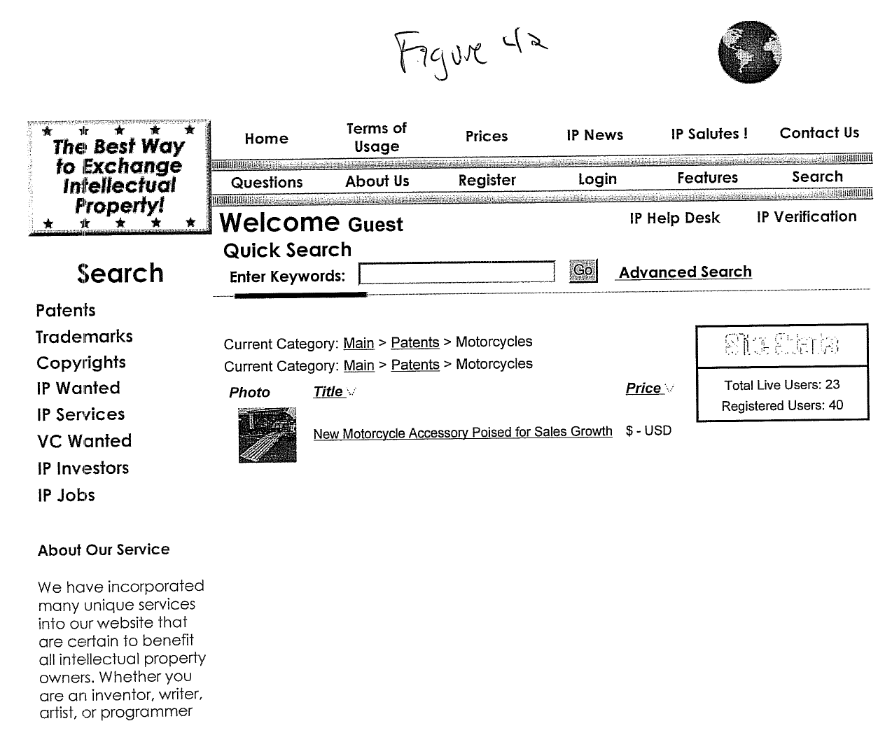

FIG. 43 is a print-out from the inventive website;

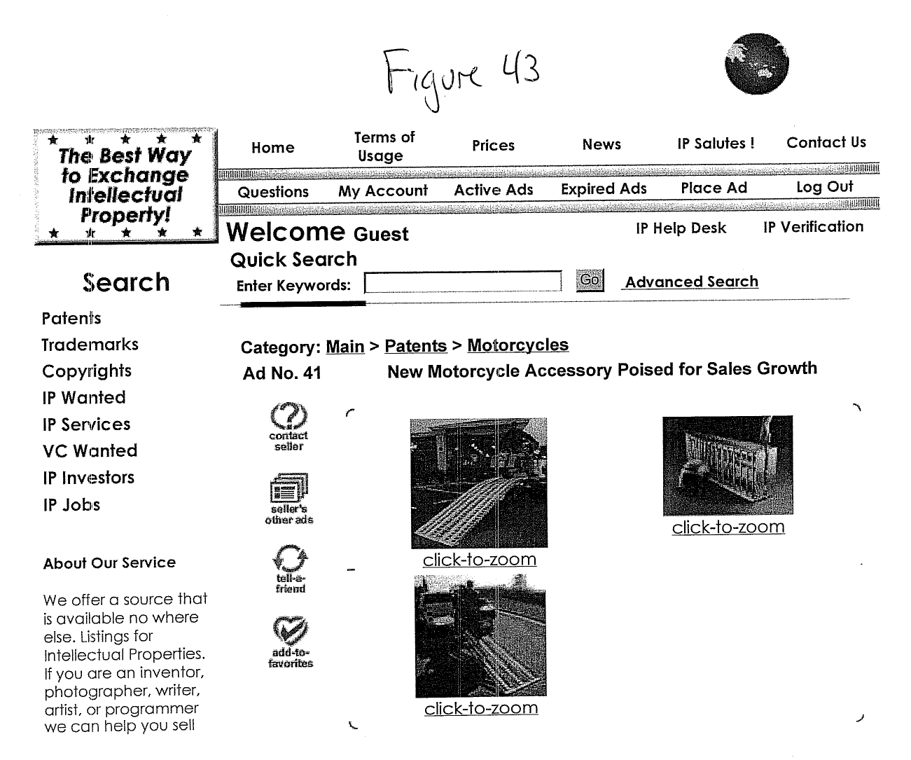

FIG. 44 is a print-out from the inventive website;

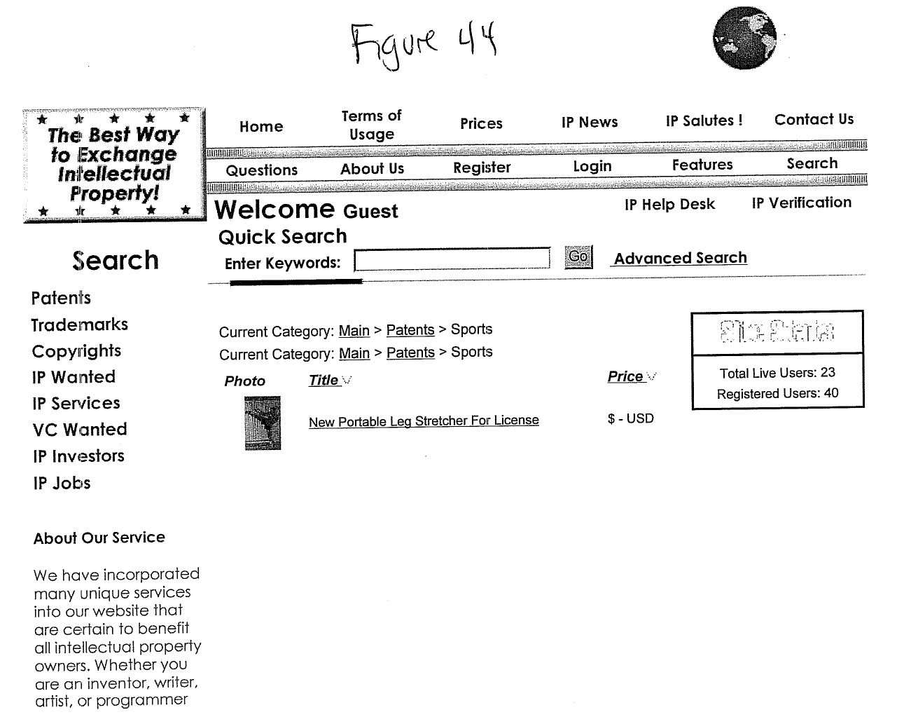

FIG. 45 is a print-out from the inventive website;

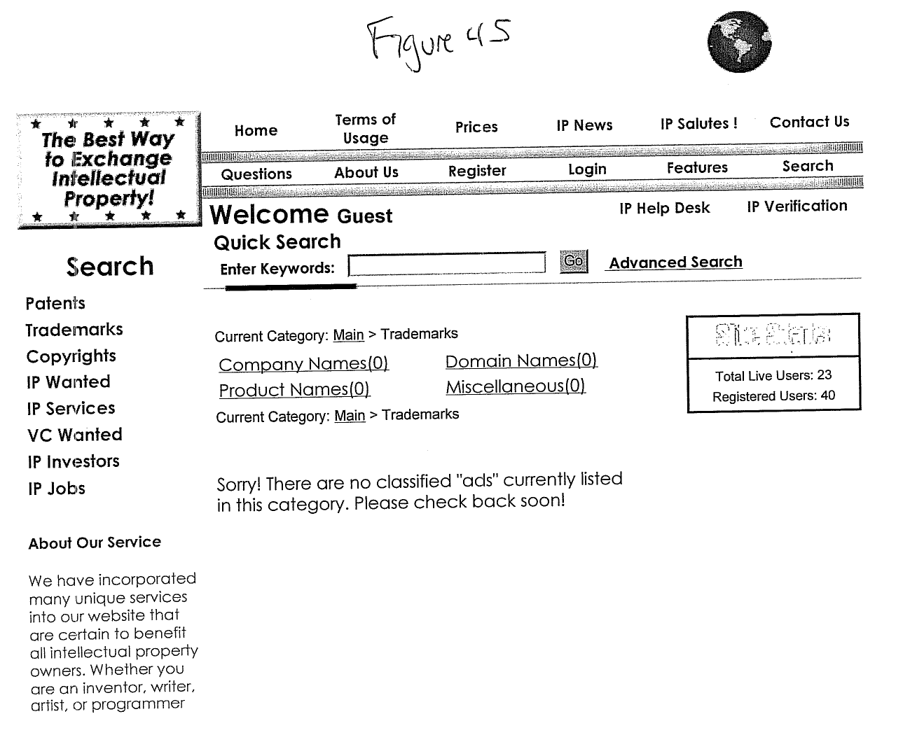

FIG. 46 is a print-out from the inventive website;

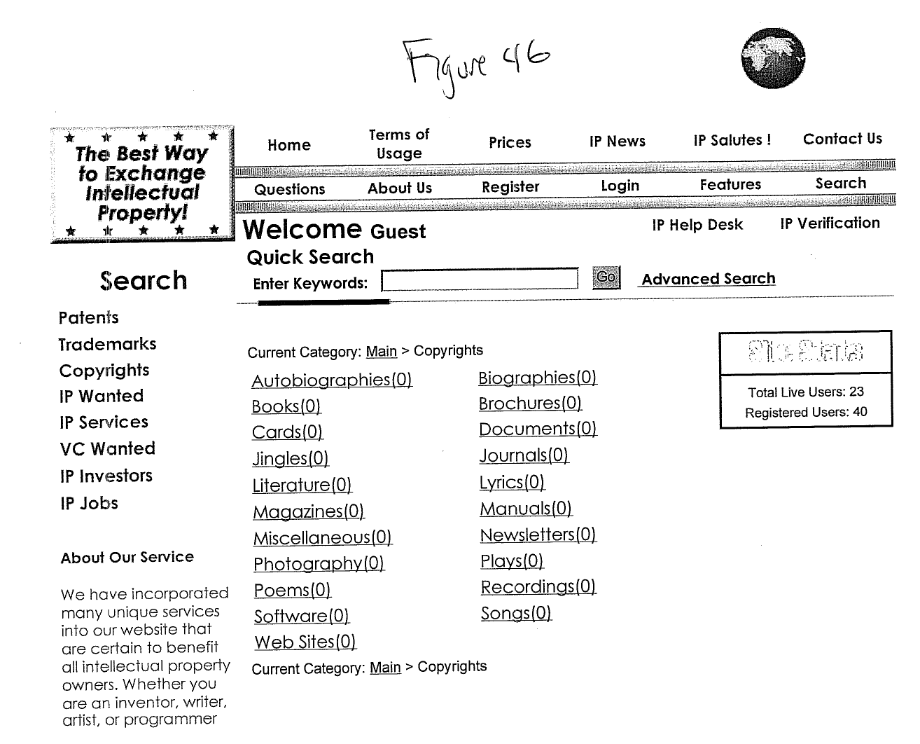

FIG. 47 is a print-out from the inventive website;

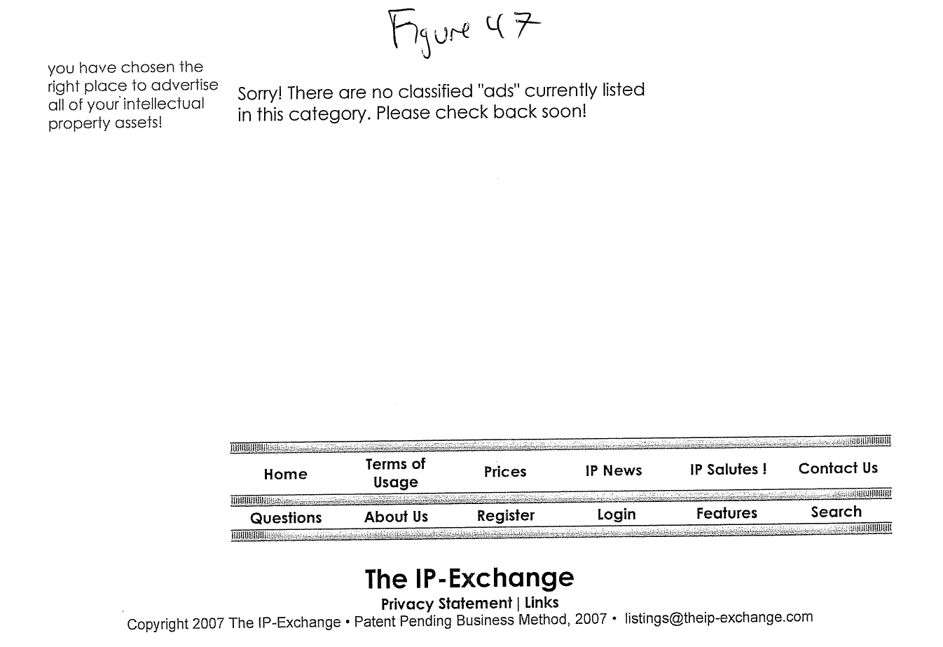

FIG. 48 is a print-out from the inventive website;

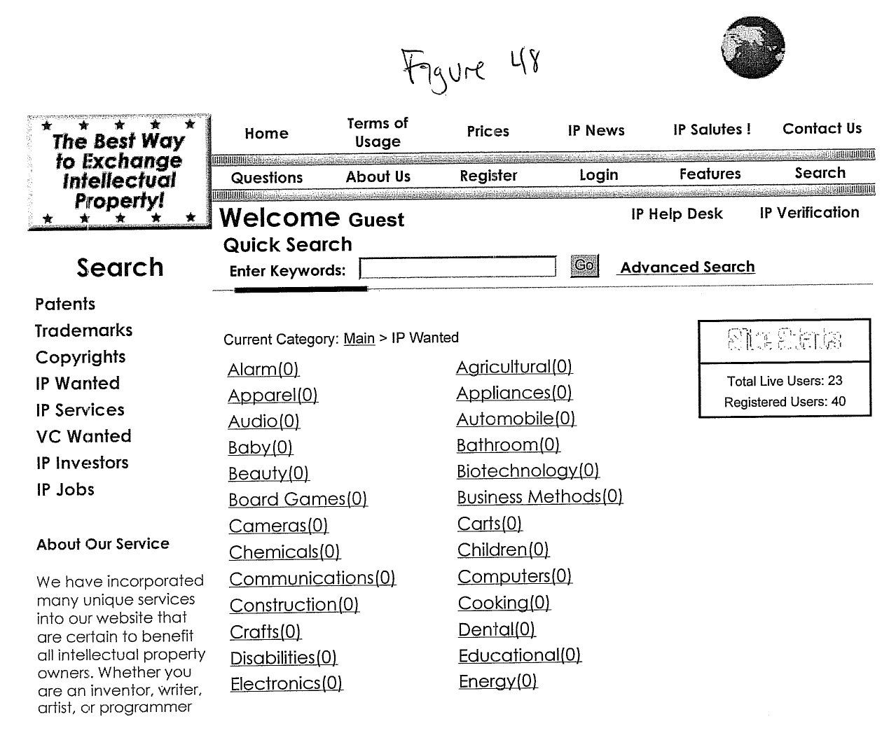

FIG. 49 is a print-out from the inventive website;

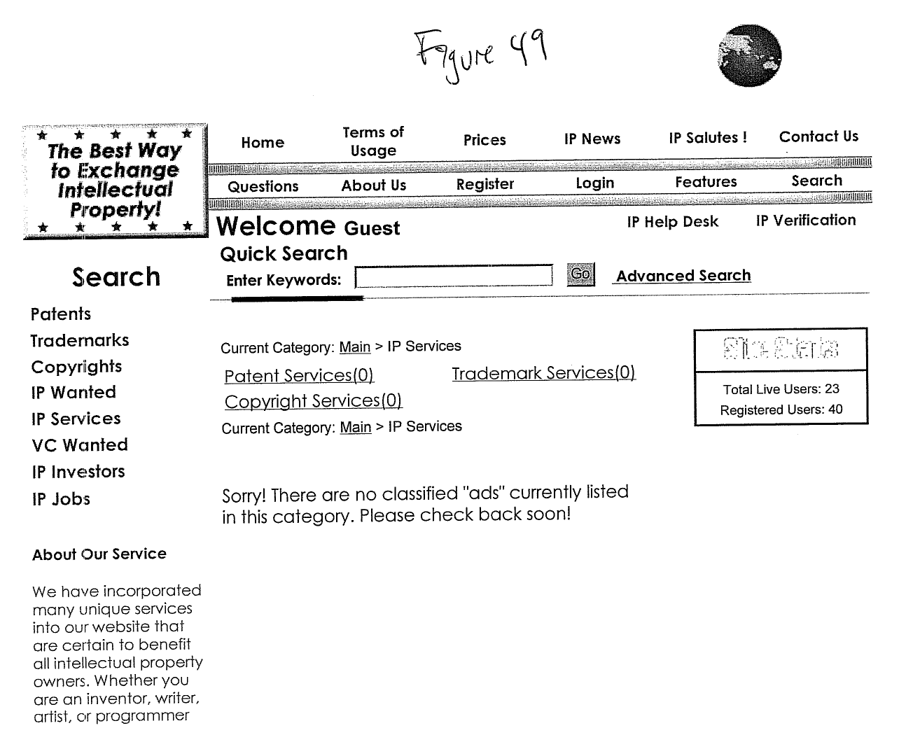

FIG. 50 is a print-out from the inventive website;

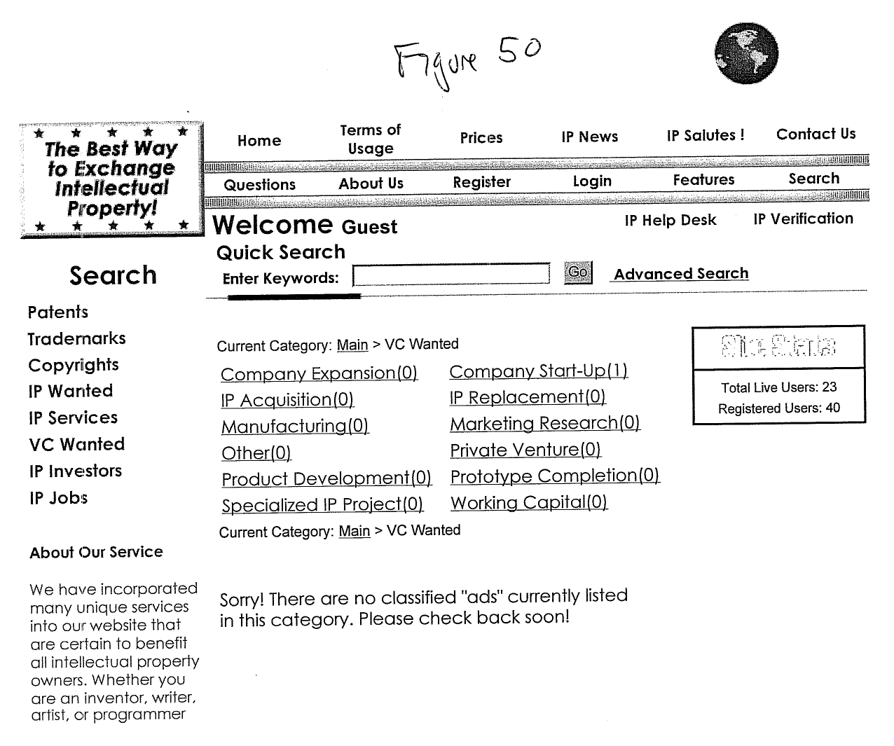

FIG. 51 is a print-out from the inventive website;

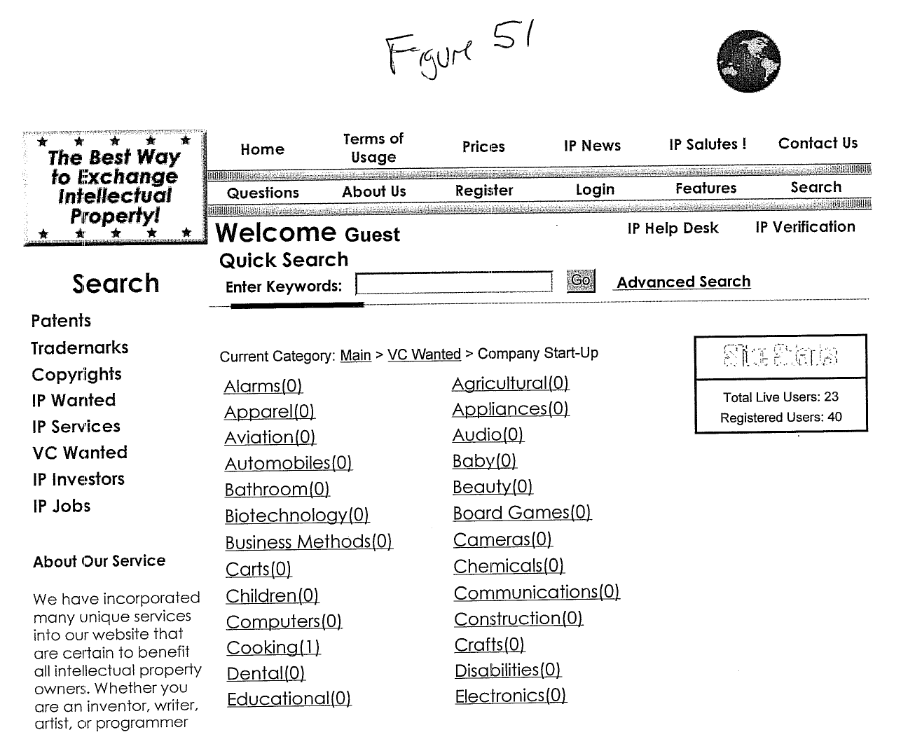

FIG. 52 is a print-out from the inventive website;

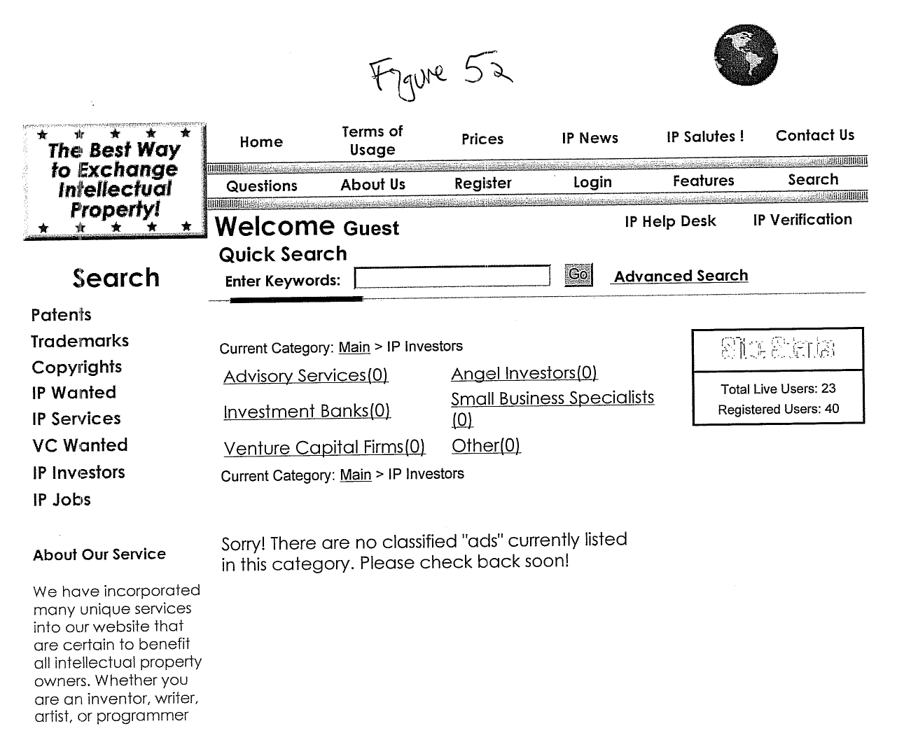

FIG. 53 is a print-out from the inventive website;

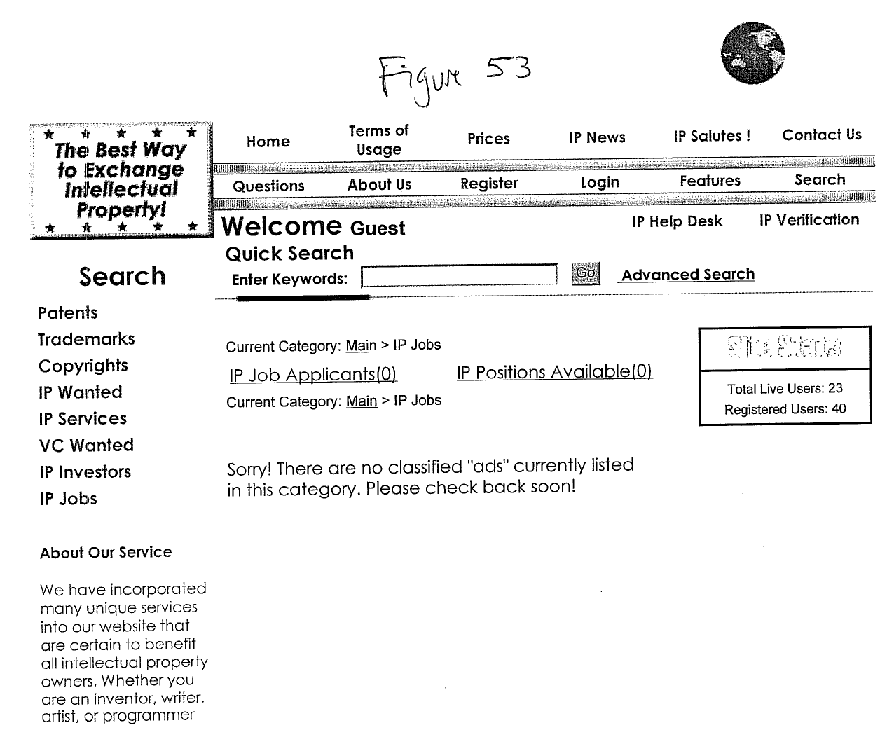

FIG. 54 is a print-out from the inventive website; and,

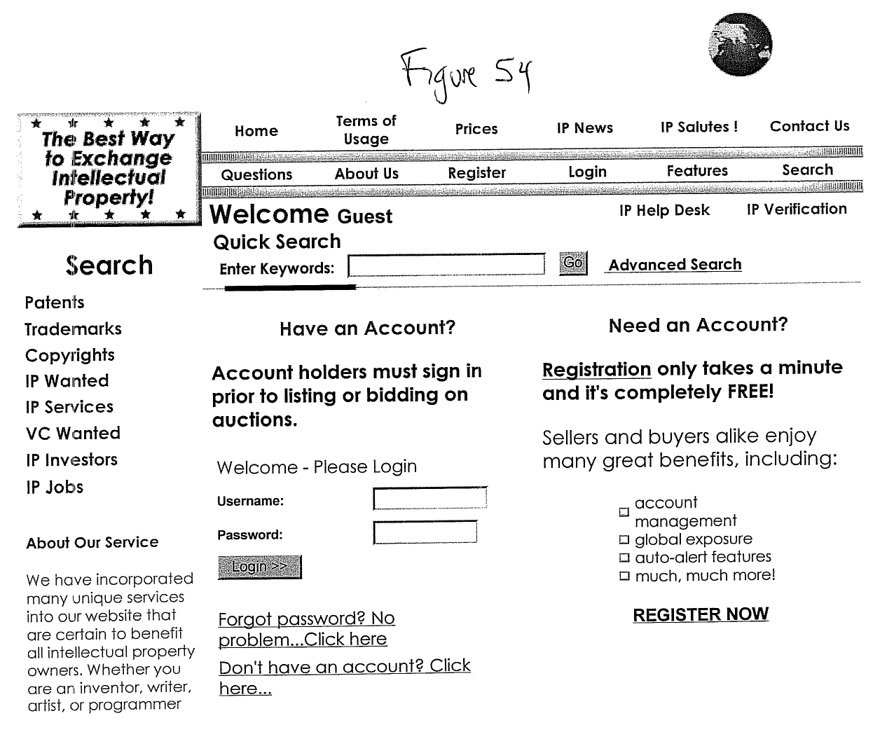

FIG. 55 is a print-out from the inventive website.

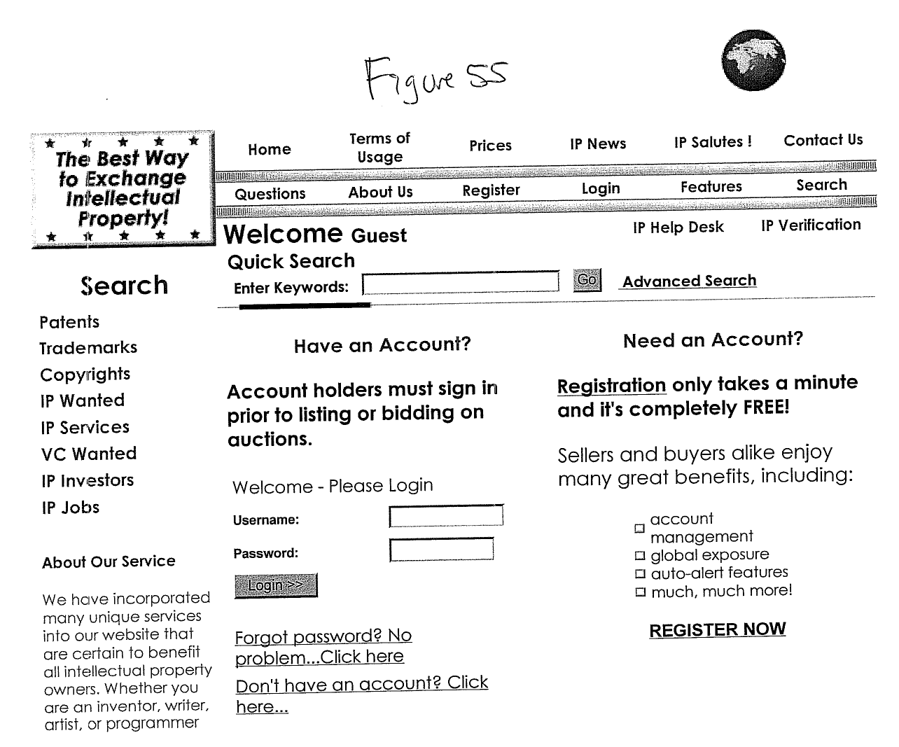

### IV. DESCRIPTION OF THE INVENTION

In one embodiment, the inventive method facilitates cross-licensing arrangements between private inventors, each of whom may need the other inventor's intellectual property rights in order to effectively implement their own invention. This embodiment could also encompass the cross-licensing between companies or between a company and an independent inventor.

In another embodiment, an inventor may have conceived an invention, but does not wish to develop it further, and is interested in cross-assigning his rights to another entity, who is similarly disinterested in pursuing their own invention, but both the first and second inventors are interested in pursuing the other's invention. The process would provide means for such inventors to find projects that interest them and attain rights to those inventions.

The following is an example frequently asked questions from the inventive process:

### Q. How do I Get a Patent, Trademark, or Copyright on My Idea?

A. To have an idea legally protected by a patent, trademark, or copyright the first thing that should be done is to contact the Intellectual Property Agency, or Authority established in your territory. The ‘IP Verification’ is a red button located below the main tool bar on our home page and is visible from every page. This button provides a list of direct links to the Internet home pages of Intellectual Property Agencies and Authorities established in various areas of the world. Clicking on the home page of the authority in your territory will enable you to access the appropriate contact information for that particular filing agency. The designated authorities in your area will be able to describe the type of legal protection needed for your particular territory and project, and best direct you toward the type of assistance necessary for your situation.

To have an idea covered by a patent or trademark, you will most likely need to locate a patent agent, or patent attorney to find out exactly how to go about the process. You can locate a professional near you by clicking on our ‘IP Services’ button located on the left side of the home page. You can scroll through the list of IP Service Providers until you make a selection. You should always check with the credentials of the person that you have selected to work with before you decide to give them your business. The links contained in the ‘IP Verification’ can be used to verify if someone is a registered practitioner, in addition to providing the contact information to the filing agency in your area. A quick phone call or e-mail to one of these professionals, or agencies can provide you with some very basic information as to how to begin the legal protection process.

### Back to Top

### How do I Place an Intellectual Property Ad?

The first thing that that you must do before placing an ad on the IP-Exchange web site is to register. Registration can be preformed by clicking on the ‘Registration’ button at the top of the home page. Once you have filled out a simple form you will be logged into the system and welcomed. None of the information gathered on this web site is shared with prate or public agencies. If you have already completed the registration process then you must simply login by entering your user name and password. Once you are logged in the menu on the main tool bar on the top of the page will change to accommodate your needs as a registered member. You will then need to click on ‘Place Ad’, and then select the desired category to access the appropriate order form.

The order forms are formatted to help you to structure your ideas quickly, and easily. Again, it is important to remember that you must agree to abide by all rules and regulations that govern this web site by signing a disclaimer, otherwise your ad will be discarded without refund. Next, take your time and fill in your listing information in the fields that the order form provides. Once the text for your order form is complete, you will then need to click the ‘Enter Ad Details’ button that is located at the bottom of the order form. You will then be taken to the ‘Image Collection Page’ where you can enter any photos, or icons that you would like to have appeared in your ad. The system will give you some ‘Editing Options’ that will enable you to correct any mistakes that you may have made during the input process.

Finally, it is important to know that the IP-Exchange is a secured web site, and you can make your payments thought the convenience of Pay Pal. Therefore, simply make the appropriate payment for the time length of the ad that you have selected and click ‘Submit.’ After you have completed these simple steps, your ad will instantly appear on line! For best marketing results, be sure to e-mail the companies in your field and let them know where you ad is displayed.

### Back to Top

How do I Know where to Place in My Ad?

Strategic planing is always the most important part of any successful formula! Therefore, we suggest that you take a look around The IP-Exchange before placing and ad, especially if this is your first time visiting our web site. The place of primary significance is our ‘Rules & Regulations’ page. This page will give you the guidelines by which to follow when constructing the content for the ad. Once you have reviewed our Rules & Regulations you will also better understand what are considered to be acceptable materials, and practices for each and every listing. Next, you should look at our ‘Prices’ page to select a length of time that best suits your budgeting, and advertising needs.

Before placing your ad, it is also helpful to make note of several useful points. First, you will need to examine the primary search headings, in order to identify which type of intellectual property advertising slot would most suites your specific needs. The primary search headings consist of ‘Patents,’ ‘Trademarks,’ ‘Copyrights,’ ‘IP Wanted,’ ‘IP Services,’ ‘VC Wanted,’ ‘IP Investors,’ and ‘IP Jobs.’ You can find out more about each type of advertisement slot that we offer by reading the information about each type below on this page. Secondly, you may want to look around and male note of what field, or industry specific category that your intellectual property would best is displayed in. Thirdly, it is helpful to scan some of our exiting ads and examine the precise questions in advance that you may want to provide answers to for your own listing. When you feel prepared to place your ad, you must simply click on the appropriate order form that represents the type of ad that you would like to place and begin.

### Back to Top

### What Listing Information is Contained in the ‘Patent’, ‘Trademark’, & ‘Copyright’ Ads?

The ‘Patent,’ ‘Trademark,’ and ‘Copyright’ ads are uniquely designed, single listing advertise slots purchased by intellectual property owners who would like to display their work on-line to a global audience. The IP-Exchange order forms are structured in a way that will enable the seller to secure a buyout, licensing agreement, cross licensing agreement, or even trade their intellectual property. These ads are ideal for any private inventor, development team, company, firm, or anyone else that would like to secure a deal on their existing intellectual property assets.

The main goal of The IP-Exchange is to equip our clients will all of the tools necessary to secure a quick, and simple on-line deal. We pride ourselves on our patent pending business methods and features that help make this possible. As a convenience to you, one of our unique on-line features available in our single listing ads will enable you to display and print an entire legal contract for the intellectual property that you are listing. In addition, by simply placing the desired information into the proper fields on the order form, the exchange system will automatically format ‘Portfolio Services,’ as well as the additional featured services. The single listing IP ads will vary in posting duration dependent upon the length of listing time purchased by the seller.

The single listing intellectual property information that is to be posted must be placed on one, single order form per single Patent, Trademark, or Copyright listing. Any attempt to place more than one issued work on a single application order form will be discarded without refund. For example, if one inventor wants to post two similar inventions that possess different patent numbers, that inventor would need to complete two separate order forms, and purchase two separate ads. Another example would be that if an inventor has a hardware invention that is patented, but that patented invention contains software that is copyrighted, and the inventor would like to sell the patent and copyright separately; the information would be placed on two separate order forms, and charged as two separate ads.

Please note, that it is permissible to include software that is integrated within an invention into a patent deal, however this must be indicated in section E. Transaction Information, by placing notation in the box for ‘Sellers Comments.’ The general rule to follow is one issued work type, (Patent, Trademark, or Copyright) per listing, unless included within the sale of an issued work. The copyright sale of a particular volume, or a series, can be placed on a single ad, but can only be sold separately on separate advertisement listings. If you should have any questions regarding this practice, please feel free to contact us before making a listing decision.

### Back to Top

### What Information is Contained in the ‘IP Wanted’ Ads?

The ‘IP Wanted’ ads are used for when you, or your company has a need for an IP-based product that is not currently available on our web site. Our highly affordable ‘IP Wanted’ ads enable your company to create and structure your own intellectual property wanted listings that will help then to find the perfect, and absolute latest, industry specific products. The ‘IP Wanted’ ads are designed for locating a specific type of Patented, Trademarked, or Copyrighted work to secure, or invest in. These ads are perfect for businesses that do not have an intellectual property, legal, or product development department, as well as those who do.

By noting the highly detailed, and industry specific requirements necessary to fulfill all of the product needs that you are currently seeking into an ‘IP Wanted’ ad, this ad will help you to locate the ideal concept, product, or designer, needed to help your company succeed. Private inventors, attorneys, artists, authors, and various other intellectual property owners and professionals are given the opportunity to contribute to the innovation process of product development, which is the backbone of a healthy economy. In return, you will save thousands on costly design, development, legal, and travel expenses when purchasing new products from our intellectual property service.

In addition, these ads are great for all highly competitive companies that are seeking to purchase related IP projects, and products off of the market so that they can stay on top. These ads are also great for busy companies, or firms, that need to save time, and money when locating and securing these purchases. Our communication services will enable you, and your company to correspond with the most innovative inventors, and product developers in the industry. Best of all, our ads are affordable for even the smallest businesses. These ads can run consecutively for 1 full year, unless pulled by the subscriber.

### Back to Top

### What Listing Information is Contained in the ‘IP Services’ Ads?

‘IP Services’ ads are advertising slots reserved only for those existing individuals, firms, businesses, or corporations who would like to promote that they are established, and able to contribute to the intellectual property development at any stage of the process. We strongly encourage all IP Professionals and companies to be a part of the listing services that The IP-Exchange offers whether you build prototypes, are an IP Speaker, or assist in royalty negotiations. Please take a moment to review the ‘IP Services’ search categories to help you to decide where you feel that your company, firm, or service would best be displayed. The business ads are a great way to let everyone know that your intellectual property services are readily available. The business ads purchased will appear under the ‘IP Services’ heading only. The ads will then run consecutively for 1 full year, unless pulled by the subscriber.

Please note that if you are a Venture Capital, or a Financial Instruction that would like to advertise with us, please place your ad information under the ‘IP Investors’ category heading. Check out the criteria for the ‘IP Investors’ section as described below. Again, please feel free to contact us prior to placing your listing if you should have any question regarding this practice. As will all of our ads, any attempt to place more than one business ad on a single application order form will be discarded without refund.

### Back to Top

### What Listing Information is Contained in the ‘Venture Capital Wanted’ Ads?

Our ‘Venture Capital’ ads were created for all intellectual property owners who have financial needs based upon their inventions, software development projects, or any other IP project that requires venture capital funding. These ads will help you to better structure and display your financial needs in a way that will let the philanthropist, angel, and corporate investors view your goals so that they know exactly what you are going to accomplish. These ads will professionally display your existing IP work, or works targeted for growth, as well as outline the financial intentions that you have for your particular method of development. These ads are designed to optimize the chances of achieving your plans whether you are seeking funding for start-up seed, expansions, IP Acquisitions, or IP replacement of outdated technology.

Thanks to The IP-Exchanges customized order forms, inventors, developers, and companies finally have a simple and fast way to include others in their intellectual property visions and goals. The ‘Venture Capital Wanted’ order forms will help you to produce interactive and informative ads. These ads are intended to assist you in generating the funding needed for any simple or specialized project such as prototype completion, product development, marketing research, and even private intellectual property ventures. To help ensure your success, you can even enter and display the full text of your business model, and accompanying legal contract. The Venture Capital ads will vary in posting duration dependent upon the length of listing time purchased by the seeker.

### Back to Top

### What Listing Information is Contained in ‘IP Investors’ Ads?

The ‘IP Investors’ ads are specifically reserved for angel investors, venture capital firms, investment banks, venture capital firms, small business specialists, and advisory service providers in additional to any other public or private establishments that are willing to assist inventors and entrepreneurs in the area of funding. These ads enable financially based institutions to showcase their services and increase their number of qualified applicants. To advertise with us, you must be willing to fund an intellectual property based project at any one of its' various stages. When placing an ‘IP Investors’ ad, we ask that you please specify the particular industry fields for which you are willing to fund intellectual property. This will enable the serious industry developers to locate your services far more efficiently. The ads will then run consecutively for 1 full year, unless pulled by the subscriber.

### Back to Top

### What Listing Information is Contained in the ‘IP Jobs’ Ads?

The ‘IP Jobs’ listings will help you to locate the industry professionals needed to complete any IP project. The ‘IP Jobs’ ads are ideal for when you, or your company has a need for an IP-related service that is not currently available on our web site. These ads are perfect for businesses that do not have an intellectual property, legal, or product development department, as well as those who do. The ‘IP Jobs’ ads are designed for locating an IP based job, or job applicant with very specific qualifications.

Our ‘IP Jobs’ listings will assist you in locating the perfect industry professionals needed for your company, or IP project in a way that is fast and easy. By simply noting the highly detailed, and industry specific requirements necessary to fulfill all of needs that you are currently seeking into an ‘IP Jobs’ ad, this ad will help you to locate the ideal project partner, designer, developer, attorney, or other qualified assistance needed to help your company succeed. Private inventors, attorneys, artists, authors, and various other intellectual property professionals are made aware of the opportunity to collaborate and contribute to the innovation process.

Not only can the ‘IP Jobs’ ads be used when seeking a particular type of job position, or applicant in the IP industry, but they can also be used to locate IP Salesperson, Project Assistance, Project Managers, Project Partners, and even necessary IP Club Officials. The ads are great for all independent inventors that seeking help on a particular project. These ads are also great for busy law firms, or companies that need to save time, and money when seeking the right staff, and HR help for their IP projects. Our communication services will enable you, and your company to correspond with the most innovative professionals in the industry. Best of all, our ads are affordable for even the smallest businesses. These ads can run consecutively for 1 full year, unless pulled by the subscriber.

### Back to Top

### What is the ‘IP Help Desk’?

The ‘IP Help Desk’ is an exclusive, free service provided by The IP-Exchange that enables buyers, and sellers communicate without cost to either of them. The ‘IP Help Desk’ is a chat room designed specifically for those who have products and services displayed on our web site to have a live exchange of valuable information with those who may be interested. Anyone inquiring about the products or services on our web site may use the service. When you locate a product or service of interest, simply check the inside of the ad for the time in which the representative will be available at the ‘IP Help Desk.’ You may then enter the chat room at the times posted to speak with that particular seller, or professional.

The ‘IP Help Desk’ is the ideal place to discuss the problem solving techniques, special features, pricing, and other selling points in greater detail so that a deal can be made. It is also the ideal place to work out last minute contractual kinks, and bartering, making for a smooth IP transition. While you are answering questions at the ‘IP Help Desk’ it just may catch the attention of additional interested parties. This feature often saves sellers the time of having to repeat information. The ‘IP Help Desk’ is available 24 hours a day to everyone interested in intellectual property and therefore can accommodate any schedule. The only requirement for usage is that you complete The IP-Exchange registration form before logging on.

The invention has been described with reference to several embodiments.

Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method for providing at least one transaction of intellectual property rights, the method comprising the steps of:
providing a means for listing intellectual property rights;
providing means for accessing the means for listing;
providing a searchable database of the intellectual property rights; and,
categorizing the intellectual property into technology categories.
